(19) United States
(12) Patent Application Publication
(10) Pub. No.: US 2013/0218758 A1
(43) Pub. Date: Aug. 22, 2013

(54) CUSTOM SCORECARD AND HYBRID FRAUD MODEL

(71) Applicants: Andrew John Bruno Naumann zu Koenigsbrueck, Vashon, WA (US); Cory Howard Siddens, Mountain View, CA (US); Benjamin Scott Boding, Mountain View, CA (US)

(72) Inventors: Andrew John Bruno Naumann zu Koenigsbrueck, Vashon, WA (US); Cory Howard Siddens, Mountain View, CA (US); Benjamin Scott Boding, Mountain View, CA (US)

(21) Appl. No.: 13/770,895

(22) Filed: Feb. 19, 2013

Related U.S. Application Data
(60) Provisional application No. 61/599,797, filed on Feb. 16, 2012.

(51) Int. Cl. G06Q 20/38

(52) U.S. Cl. CPC G06Q 20/382
USPC 705/39

(57) ABSTRACT

Embodiments of the invention relate to methods, apparatuses, and systems for performing, creating, generating, and displaying transaction scorecards related to fraud evaluations of transactions. Methods may include determining if one or more preselected rules are triggered by transaction data associated with a transaction, determining a trigger score for each of the preselected rules, adding the trigger score for each of the preselected rules to a profile score, applying the profile score to at least one transaction decision rule, and displaying transaction evaluation results in a transaction scorecard. Additionally, some embodiments of the invention may combine a centralized multiple merchant fraud model provided by a merchant processor and a merchant customized model, to a produce a hybrid scorecard model. The respective scores of the multiple merchant fraud model and the merchant customized model may be weighted for further customization.

CROSS-REFERENCES TO RELATED CASES

The present invention is a non-provisional of and claims priority to U.S. Provisional Application No. 61/599,797, filed on Feb. 16, 2012, by Koenigsbrueck et al., the entire contents of which are herein incorporated by reference for all purposes.

### BACKGROUND

Fraudulent transactions are a continuing problem for merchants who can be held liable for all or a portion of the losses resulting from such transactions. Fraudulent transactions where a valid card is used by a thief are particularly hard to stop because of the expansion of internet-based e-commerce and contactless transactions where it is difficult or costly to authenticate a presenter's identity. Accordingly, fraudulent transaction monitor services for merchants have been developed to monitor transactions to determine if the circumstances surrounding transaction data may give an indication of whether the transaction is fraudulent before sending the transaction data to an acquirer, payment processing network, or issuer for authentication.

Many of these fraudulent transaction monitoring solutions use conditional fraud transaction rules to determine whether the transaction data gives a high probability of being fraudulent. Fraud rules determine if conditions are present in a transaction that inform an entity whether the transaction may be accepted, monitored, reviewed, or rejected depending on the transaction details. Fraud monitoring systems can be provided by merchant processors that receive transaction data from many merchants in many different industries and determine sophisticated fraudulent rules and profiles to accurately determine when transactions are fraudulent.

Some merchant processors have their own rules built into fraud prevention profiles that have been tested on transactions from a wide range of merchants to determine the best protection from a broad range of fraudulent transactions. This multiple merchant profile score determined by the merchant processor may be helpful in protecting all merchants from general fraudulent activity that affects large groups of merchants. The merchant processor has access to a tremendous number of transactions from multiple merchants that allows it to build the most robust fraudulent rules and profiles for the widest number of merchants. As such, the merchant processor provides another layer of protection in the transaction system and helps merchant, acquirers, payment processing networks, and issuers determine if a transaction is fraudulent.

However, not every merchant business is the same and not every merchant transaction has the same fraudulent indicators. Accordingly, there is a need for merchants to be allowed to customize their fraud analysis to accurately capture their specific business. However, such customization can lead to increased risk of fraudulent transaction if such customization is not performed accurately and carefully. Accordingly, there is a further need for an easy and efficient method of customizing a fraud evaluation of a transaction in a quick, easy, and efficient manner. Furthermore, there is a need for a method of analyzing the effect of any changes in a fraud evaluation.

Embodiments of the invention address these and other problems, individually and collectively.

### SUMMARY

Embodiments of the invention relate to methods, apparatuses, and systems for creating and displaying a transaction scorecard related to a fraud evaluation of a transaction.

One embodiment of the present invention is directed to a method of performing a fraud evaluation for a transaction. The method includes determining if one or more preselected rules are triggered by transaction data associated with a transaction. The method continues by determining a trigger score for each of the preselected rules, adding the trigger score for each of the preselected rules to a profile score, applying the profile score to at least one transaction decision rule, and displaying transaction evaluation results in a transaction scorecard. Determining the trigger score for each of the preselected rules may further include setting the trigger score for the preselected rule to a preselected point value if a preselected rule of the one or more preselected rules is triggered, and setting the trigger score for the preselected rule to zero if the preselected rule of the one or more preselected rules is not triggered.

Another embodiment of the present invention is directed to a server computer. The server computer includes a processor and a computer-readable medium coupled to the processor. The computer-readable medium includes code executable by the processor for performing a method of fraud evaluation for a transaction. The method includes determining if one or more preselected rules are triggered by transaction data associated with a transaction. The method continues by determining a trigger score for each of the preselected rules, adding the trigger score for each of the preselected rules to a profile score, applying the profile score to at least one transaction decision rule, and displaying transaction evaluation results in a transaction scorecard. Determining the trigger score for each of the preselected rules may include setting the trigger score for the preselected rule to a preselected point value if a preselected rule of the one or more preselected rules is triggered, and setting the trigger score for the preselected rule to zero if the preselected rule of the one or more preselected rules is not triggered.

Another embodiment of the present invention is directed at a method of performing a fraud evaluation for a transaction. The method includes determining a multiple merchant profile score for the transaction and determining a weighted multiple merchant profile score by weighting the multiple merchant profile score by a preselected multiple merchant profile weighting. The method continues by determining a custom merchant profile score for the transaction and determining a weighted custom merchant profile score by weighting the custom merchant profile score by a preselected custom merchant profile weighting. The method further includes determining a hybrid profile score for the transaction by adding the weighted multiple merchant profile score and the weighted custom merchant profile score, applying, by one or more processors, the hybrid profile score to at least one transaction decision rule, and displaying transaction evaluation results in a hybrid transaction scorecard for a merchant.

Another embodiment of the present invention is directed to a server computer. The server computer includes a processor and a computer-readable medium coupled to the processor. The computer-readable medium includes code executable by the processor for performing a method of fraud evaluation for a transaction. The method includes determining a multiple merchant profile score for the transaction and determining a weighted multiple merchant profile score by weighting the multiple merchant profile score by a preselected multiple merchant profile weighting. The method continues by determining a custom merchant profile score for the transaction and determining a weighted custom merchant profile score by weighting the custom merchant profile score by a preselected custom merchant profile weighting. The method further includes determining a hybrid profile score for the transaction by adding the weighted multiple merchant profile score and the weighted custom merchant profile score, applying the hybrid profile score to at least one transaction decision rule, and displaying transaction evaluation results in a hybrid transaction scorecard for a merchant.

These and other embodiments of the invention are described in further detail below.

### BRIEF DESCRIPTION OF THE DRAWINGS

FIG. 1 shows a transaction system according to one embodiment of the present invention.

FIG. 2 shows a merchant processor in a portion of a transaction system according to one embodiment of the present invention.

FIG. 3 shows a flow chart describing a method of creating a profile scorecard according to one embodiment of the invention.

FIG. 4 shows a transaction scorecard according to one embodiment of the present invention.

FIG. 5 shows a flow chart describing a method of creating a hybrid model profile scorecard according to one embodiment of the invention.

FIG. 6 shows a hybrid transaction scorecard according to one embodiment of the present invention.

FIGS. 7A and 7B show exemplary graphical user interfaces for a merchant to generate a custom merchant profile score rule for use with embodiments of the present invention.

FIGS. 8A and 8B show exemplary graphical user interfaces for a merchant to set a transaction decision rule using a custom value or a multiple merchant profile score, according to embodiments of the present invention.

FIG. 9 shows an exemplary graphical user interface for a merchant to generate and select custom merchant rules including rule conditions and trigger scores, according to embodiments of the present invention.

FIG. 10 shows an exemplary graphical user interface for a merchant to generate a custom merchant profile for use with embodiments of the present invention.

FIG. 11 shows a transaction scorecard screenshot according to another exemplary embodiment of the present invention.

FIG. 12 shows an exemplary report including a comparison of profile scores for a multiple merchant profile score and custom merchant profile score according to an exemplary embodiment of the present invention.

FIG. 13 is a high level block diagram of a computer system that may be used to implement embodiments of the present invention.

### DETAILED DESCRIPTION

Embodiments of the invention relate to generating and presenting a transaction scorecard related to a fraud evaluation of a transaction. The transaction scorecard may be generated using a merchant fraud profile having a number of merchant defined or selected fraud rules, where the scores for each rule can be weighted or customized to alter the impact each rule has on a fraud transaction decision. For example, for a given transaction, the profile score might be “85”. The merchant profile may be given a “score” for the transaction by totaling up the points for each rule. The profile score may then be used to determine a decision for the transaction (e.g., whether to approve or decline the transaction). The transaction decision, outcome of the fraud rules, impact each fraud rule has on the transaction decision and profile score, and any other relevant information may then be displayed for a user (i.e., merchant) in a transaction scorecard. The transaction scorecard may allow a merchant to quickly and easily determine why a transaction decision was made and what factors, rules, and transaction data impacted the transaction decision. Additionally, in some embodiments, the status or final disposition of the transaction may be tracked so that the merchant processor may determine the accuracy of the transaction decisions.

Additionally, merchants can customize fraud rules, merchant profiles, and transaction decision rules to make automated decisions for received transaction requests from consumers. Merchants can configure a custom fraud profile that may include multiple fraud rules. The custom merchant profile may include multiple fraud rules and multiple transaction decision rules that determine a merchant processor's actions regarding a transaction. The transaction decision rules may provide different results depending on whether one or more rules are triggered by a transaction. Merchants can customize their merchant profiles by choosing which fraud rules to use in fraud evaluations of their transactions and can allocate points to be given to each rule if triggered. The merchant can choose pre-defined rules or the merchant can define their own rules to use in the fraud evaluation. The merchant can also determine transaction decision rules that use the profile score of the transaction to determine an appropriate transaction decision. The profile score may be determined by comparing the transaction data to the selected rules to determine if the rules are triggered and adding the trigger scores for rules that are triggered by the transaction data. Triggered rules may have a predetermined trigger score that may be selected and customized by a merchant. A transaction scorecard may display all of this information and more in an easily understandable format.

For example, a merchant profile may have ten rules selected or created by a merchant and a transaction may trigger four of those ten rules. The four triggered rules may have trigger scores that may be added to equal a total profile score of 85 points. The profile score may then be applied to one or more transaction decision rules to determine an action for the corresponding transaction (e.g., reject, approve, monitor, or review). For example, a transaction decision rule may state that if the score is above 80, the transaction may be rejected (i.e., declined). Accordingly, the transaction may be rejected because the profile score of 85 has a score that is larger than 80. Accordingly, the merchant processor may reject the transaction and may inform the merchant that the transaction is likely fraudulent. In some embodiments, the merchant processor may automatically decline the transaction. Accordingly, the transaction may be rejected before an authorization request message is sent to an acquirer, payment processing network, or issuer. As such, merchants may limit their liability for fraudulent transactions by implementing more accurate fraud monitoring systems before transactions are entered into a typical transaction processing system. Alternatively, the merchant processor may provide a recommendation to a merchant to reject the transaction. Additionally, the status or final disposition of the transaction may be tracked such that the merchant may determine whether the merchant fraud profile transaction decision was accurate. For example, the system may determine the number of approve transaction may later be determined to be fraudulent.

Accordingly, embodiments of the present invention may provide an easy tool for merchants and other developers to provide sophisticated fraud protection that is customized to their particular business. Therefore, embodiments provide the technical advantages of improved protection from fraudulent transactions by implementing more accurate fraud detection tailored to a merchant's particular business. Additionally, the scorecard display of the fraud evaluation results for a transaction improves the speed, efficiency, and accuracy of fraud rule development and testing. Furthermore, tracking the status of transactions and their final disposition may allow a merchant to obtain feedback regarding the accuracy of their fraud profiles. Finally, storing of the transaction results for later review allows developers to further improve testing and development by using new rules or weighting of profiles on past transaction data to improve the speed and efficiency of implementing new fraud rules.

Additionally, another embodiment of the invention combines a centralized multiple merchant fraud model and a customized merchant fraud model to a produce a hybrid fraud model. The multiple merchant fraud model may be provided by a merchant processor that has access to transaction data from a large number of merchants. The respective scores of the centralized multiple merchant fraud model and the customized merchant model may be weighted for further customization. The hybrid model produces a hybrid profile score that is a combination of the other model scores. The hybrid profile score may be used in the same manner as the single custom merchant profile score described above. Additionally, the individual scores could be used to provide further customization of the fraud profile and transaction decision rules. Accordingly, the hybrid fraud profile may allow a merchant to build on the collective wisdom and enormous number of transaction of multiple merchants but also tailor results to their specific business, clients, or industry. Alternative embodiments of the hybrid fraud profile may alter an initial multiple merchant profile score using a custom merchant profile without weighting the different profile scores. For example, a multiple merchant profile score may be used as an initial profile score and may then be altered through the triggering of rules in a custom merchant profile.

Additionally, statistical analysis may be provided in a report or as part of the scorecard that compares the custom profile scores to the multiple merchant profile scores and even the hybrid model profile scores. In this fashion, the merchant can quickly and easily determine which model is the most accurate as well as quickly and easily determine whether changes in the customized model are required or may be beneficial. If the scores are provided on different scales (e.g. the multiple merchant profile score is provided in a range from 0-99 but the custom merchant score can be as high as 200 or more) the scores can be normalized prior to comparison so that statistically relevant results can be provided.

Prior to discussing embodiments of the invention, a further description of some terms can be provided for a better understanding of the invention.

A “fraud evaluation” may include any method of analysis, testing procedure, or series of decisions regarding a request, initialized transaction, or any other event to determine whether the request or event was initiated by a legitimate source. For example, a fraud evaluation of a transaction may include analyzing transaction data associated with a transaction to determine if the transaction was likely initiated by the proper account holder of the account and not initiated by a malicious third party using a stolen consumer product, account, password, or other information.

A “transaction” may include any event or communication of information between two entities. For example, a transaction may include a purchase transaction for a good or service between a consumer and a merchant. The transaction may be initiated in person or remotely using communication networks. Remote transactions may include a card-not-present (CNP) transaction where a cardholder or consumer is not in the presence of the merchant or other entity receiving the payment in exchange for a service or good. CNP transactions may have an inherently higher risk of fraud because a merchant cannot easily check the identification and credentials of the consumer presenting the payment account to ensure the presenter is the designated cardholder or accountholder.

According to embodiments of the present Invention, “transaction data” may include any information associated with a transaction. For example, if the transaction is a payment transaction, transaction data may include an account number, the name of the account holder, the residential address for the account holder, the delivery address for a purchased product, the bank identification number (BIN) of the issuing bank associated with the account, the transaction amount, a merchant identifier for a merchant associated with the transaction, the volume of the transaction, information about the goods or services being purchased, the merchant location, and any other information that is related to the current transaction.\

A “preselected rule” may include a conditional rule associated with transaction data that may be selected by a merchant and associated with a value or point total if the condition is met. For example, a merchant may select a preselected rule related to the bank identification number (BIN) of an account used in a payment transaction. The exemplary preselected rule may include a condition that if the BIN of an account used in the payment transaction is associated with a bank originating in a different country, the rule is triggered, flagged, or otherwise selected by the system such that the system knows that the condition associated with the rule has been met or otherwise satisfied. The rule may be associated with a point value when the condition is met or the rule is triggered.

According to embodiments of the present invention, a “trigger,” “triggering,” or being “triggered,” may include the meeting or satisfaction of a condition of a preselected rule. For example, the BIN related rule described above (“BIN Country Mismatch rule”) may be triggered if the transaction data associated with a payment transaction includes a delivery address in Thailand but includes a BIN associated with a bank in the United States. Accordingly, it may be likely that the account has been compromised and the thief is attempting to order goods to be delivered in another country (Thailand), where it may be difficult to track or arrest the thief. Accordingly, the BIN Country Mismatch rule may be triggered and the fraud score points associated with the preselected rule may be counted towards a profile score for the transaction.

A “trigger score” may include a value, magnitude, number of points, or other measure of the impact of a preselected rule on a profile score. For example, a trigger score may include a predetermined number of points (e.g., 20 points) if a preselected rule is triggered by transaction data associated with a transaction or the trigger score may include no points if the preselected rule is not triggered by the transaction data. For instance, using the example above, if the BIN of a transaction account does not match the country of the delivery address, and the BIN Country Mismatch rule is triggered, there may be a large number of preselected points assigned as the trigger score for the transaction. On the other hand, if a merchant's business regularly ships to customers that are outside of their home country with limited fraudulent purchases, the trigger score may be low for the triggered BIN country mismatch rule. Accordingly, the preselected point value of the trigger score may be set by a user (i.e., merchant) as desired for their business. Furthermore, if the BIN Country Mismatch rule is not triggered, the trigger score may be set to 0 points or may be set to negative points in some instances to further provide a neutral or positive impact on a profile score due to the rule not being triggered by the transaction data.

A “profile score” may include a measure of the risk of a transaction according to a fraud profile. For example, a profile score may include a sum of all of the trigger scores for the predetermined rules in a merchant profile for a transaction. The profile score may then be used to determine an action or decision regarding whether a transaction may be approved, denied, monitored, reviewed, or any other actions may be executed for the transaction. Additionally, the profile score may be used as a portion of a hybrid profile score that incorporates multiple profile scores before making a decision regarding a transaction.

A “hybrid profile score” may include a hybrid or combination of multiple profile scores. For example, a hybrid profile score may be determined by combining a custom merchant profile score and a multiple merchant profile score. Accordingly, a merchant may be able to implement the general security of a multiple merchant profile as well as customize the fraud evaluation for the intricacies of their particular business. In some embodiments, both a hybrid profile score and a merchant profile score may be calculated and the transaction decision differences may be compared between the different profile scores for a transaction.

A “passive profile” may include a profile that is not used in a fraud evaluation of a transaction. For example, the passive profile score may indicate what the profile score and transaction decision may have been for a transaction if the passive profile were used by the merchant. This passive profile score may allow a merchant to test a new custom merchant profile without leading to diminished fraud protection. Accordingly, a merchant may test new profiles before they affect actual transactions and may compare these results to the results of the active profile to determine if the custom merchant profile is more accurate than the current profile or profiles being used in the fraud evaluation. The scores and transaction decisions for the passive and active profiles may be saved and tracked by the merchant processor so comparisons may be made between profiles.

A “transaction decision rule” may include a conditional rule associated with an action for a transaction. The transaction decision rule may include a condition that is based on a profile score or hybrid profile score. For example, a transaction decision rule may include a condition that states if a profile score is 40 points or more, the transaction is rejected and otherwise the transaction is allowed. If the profile score is less than 40 points the transaction may be allowed and the transaction data may be passed to an acquirer or otherwise passed to a payment processing network for processing with an appropriate issuer. However, if the profile score is 40 points or more, the transaction may be rejected before being sent to a payment processing network or issuer. Additionally, the transaction decision rules may include transaction decisions including a transaction being rejected, monitored, reviewed, allowed, or any other suitable and/or available action regarding a transaction.

A “multiple merchant profile score” may include a profile score that is associated with a profile including fraud rules that indicate fraud from two or more merchants. For example, a multiple merchant profile score may indicate the risk of a transaction based on a general profile of fraud rules that tend to indicate fraudulent transactions across a large number of merchants from many different industries and customer bases. Accordingly, the multiple merchant profile score may give an indication of general fraud trends, risks, and other information related to the broad average of transactions across many different sectors of the economy. Accordingly, because the multiple merchant profile score is based on rules that indicate general fraud trends, the multiple merchant profile score may not be the most accurate fraud indicator for a particular merchant, especially if that merchant has a unique customer base, product, billing process, etc., that may fall outside typical merchant trends.

A “weighted multiple merchant profile score” may include a portion of a hybrid profile score that is associated with the multiple merchant profile. A merchant may customize their fraud evaluation to implement a hybrid scorecard that may take a portion of the value of the typical multiple merchant profile score and a portion of a custom merchant profile score to come to a hybrid merchant profile score that may still rely on the accuracy of general merchant fraud trends while still implementing aspects of a custom merchant profile based on the merchant's particular business environment. Accordingly, the weighted multiple merchant profile score may be any portion of the hybrid profile score and may be customized by the merchant to have as much or as little impact on the transaction decision as desired.

A “preselected multiple merchant profile weighting” may include a weighting coefficient of the multiple merchant profile score. The preselected multiple merchant profile weighting may be customized by a merchant to determine the amount of the overall hybrid fraud score that may be determined by the multiple merchant profile score. For example, a preselected multiple merchant profile weighting of 80% or 0.8 may provide for a hybrid profile score that has 80% of the score provided by the multiple merchant profile score. The remaining 20% may be made up of one or more other profile scores or any other scoring source.

A “custom merchant profile score” may include a profile score that is associated with a custom merchant profile based on merchant defined or selected fraud rules. For example, a custom merchant profile score may indicate the risk of a transaction based on a customized profile of fraud rules that may be tailored by a merchant to match the intricacies and unique business relationships, customers, and purchasing trends of the merchant. Accordingly, the custom merchant profile score may be customized to indicate the fraudulent transactions that tend to occur for a given merchant and may be used to provide a more accurate hybrid fraud score than a general multiple merchant fraud profile. Additionally, by using a combination of both a multiple merchant profile and a custom merchant profile, the most accurate fraud evaluation system may be implemented by a merchant, without the risk of accepting fraudulent transactions that the multiple merchant profile score may have caught.

A “weighted custom merchant profile score” may include a portion of a hybrid profile score that is associated with a custom merchant profile. A merchant may customize their fraud evaluation to implement a hybrid scorecard that may take a portion of the value of the typical multiple merchant profile score and a portion of a custom merchant profile score to come to a hybrid merchant profile score that may still rely on the accuracy of general merchant fraud trends while still implementing aspects of a custom merchant profile based on the merchant's particular business environment. Accordingly, the weighted custom merchant profile score may be any portion of the hybrid profile score and may be customized by the merchant to have as much or as little impact on the transaction decision as desired.

A “preselected custom merchant profile weighting” may include the weighting coefficient of the custom merchant profile score. The preselected custom merchant profile weighting may be customized by a merchant to determine the amount of the overall hybrid fraud score may be determined by the custom merchant profile score. For example, a preselected custom merchant profile weighting of 20% or 0.2 may provide for a hybrid profile score that has 20% of the score provided by the custom merchant profile score. The remaining 80% may be made up of one or more other profile scores or any other scoring guide that may be implemented in the system.

A “transaction scorecard” may include any display of a fraud evaluation of a transaction. For example, a transaction scorecard may be a report including one or more preselected rules, a trigger score for each of the preselected rules, a profile score, at least one transaction decision rule, and a result of the transaction decision rule associated with the fraud evaluation of a transaction. Additionally, the transaction scorecard may be interactive and may allow a merchant to request another fraud evaluation for the transaction using updated trigger scores, preselected rules, and transaction decision rules.

A “hybrid transaction scorecard” may include any display of a fraud evaluation of a transaction using more than one profile. For example, a transaction scorecard may be a report including one or more preselected rules, a trigger score for each of the preselected rules, a custom merchant profile score, a multiple merchant profile score, at least one transaction decision rule, and a result of the transaction decision rule associated with the fraud evaluation of a transaction. Additionally, the hybrid transaction scorecard may be interactive and may allow a merchant to request another fraud evaluation for the transaction using updated trigger scores, preselected rules, and transaction decision rules.

According to embodiments of the present invention, “transaction evaluation results” may include any information resulting from the fraud evaluation of a transaction. For example, the transaction evaluation results may include a decision regarding the transaction including monitor, approve, review, decline, etc. as well as transaction data, preselected rules, etc. Any information associated with the fraud evaluation, transaction, merchant, payment processing network, consumer, etc. may be included in the transaction evaluation results.

According to embodiments of the present invention, “executing the determined transaction decision” may include any action that furthers the transaction decision determined from the fraud evaluation. For example, executing the determined transaction decision may include declining the transaction and returning an authorization response message to the merchant and/or consumer informing them that the transaction has been rejected. Alternatively, executing the determined transaction decision for an approval may include forwarding a transaction authorization request message to an acquirer, payment processing network, issuer, or otherwise forwarding transaction data in order for the transaction to be processed and completed. Accordingly, executing the determined transaction decision may include multiple scenarios depending on the transaction system, the transaction decision, and further fraud prevention steps implemented by a merchant processor.

A “status of a transaction” may include the disposition of the transaction at a particular time. For example, the status of the transaction may include information regarding whether the transaction has been rejected by a consumer as being fraudulent, whether the transaction has been recharged, the product has been returned, whether the bill was paid by the consumer, or any other information related to the ultimate disposition status of the transaction as being legitimate or fraudulent.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction data associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCVV (dynamic card verification value), an expiration date, etc. An authorization request message may also comprise transaction data, such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution, a payment processing network, or a merchant processor. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment or a server computer) that indicates approval of the transaction. The code may serve as proof of authorization. As noted above, in some embodiments, a payment processing network may generate or forward the authorization response message to the merchant.

As used herein, “payment data/information” or “purchase data/information” may refer to any information corresponding to or describing purchases, orders, invoices, payments involving goods, items, services, and/or the like, and may include, but is not limited to, a purchase amount, a merchant identifier, description code (e.g., NAICS: North American Industry Classification System) associated with purchased items, cost of purchased items, and transactions as well as descriptions of purchased items, purchase dates, purchase amounts, indications of payments accounts used, indications of whether purchases were made online, confirmation numbers, order numbers, cancellation numbers, shipment status updates (e.g., order being processed, shipped, delivered, on back order, etc.), delivery tracking numbers, cancellation notices, updates, and/or the like.

As used herein, a “server computer” is typically a powerful computer or cluster of computers. For example, the server computer can be a large mainframe, a minicomputer cluster, or a group of servers functioning as a unit. In one example, the server computer may be a database server coupled to a Web server.

As used herein, an “issuer” may typically refer to a business entity (e.g., a bank or other financial institution) that maintains financial accounts for a consumer and often issues a payment device such as a credit or debit card to the consumer. As used herein, a “merchant” may typically refer to an entity that engages in transactions and can sell goods or services to the consumer. As used herein, an “acquirer” may typically refer to a business entity (e.g., a commercial bank or financial institution) that has a business relationship with a particular merchant or similar entity. Some entities can perform both issuer and acquirer functions.

### I. EXEMPLARY SYSTEMS

Provided below is a description of an exemplary system in which embodiments provided herein may be utilized. Although some of the entities and components may be depicted as separate, in some instances, one or more of the components may be combined into a single device or location (and vice versa). Similarly, although certain functionality may be described as being performed by a single entity or component within the system, the functionality may in some instances be performed by multiple components and/or entities (and vice versa). Communication between entities and components may comprise the exchange of data or information using electronic messages and any suitable electronic communication medium and method, as described below.

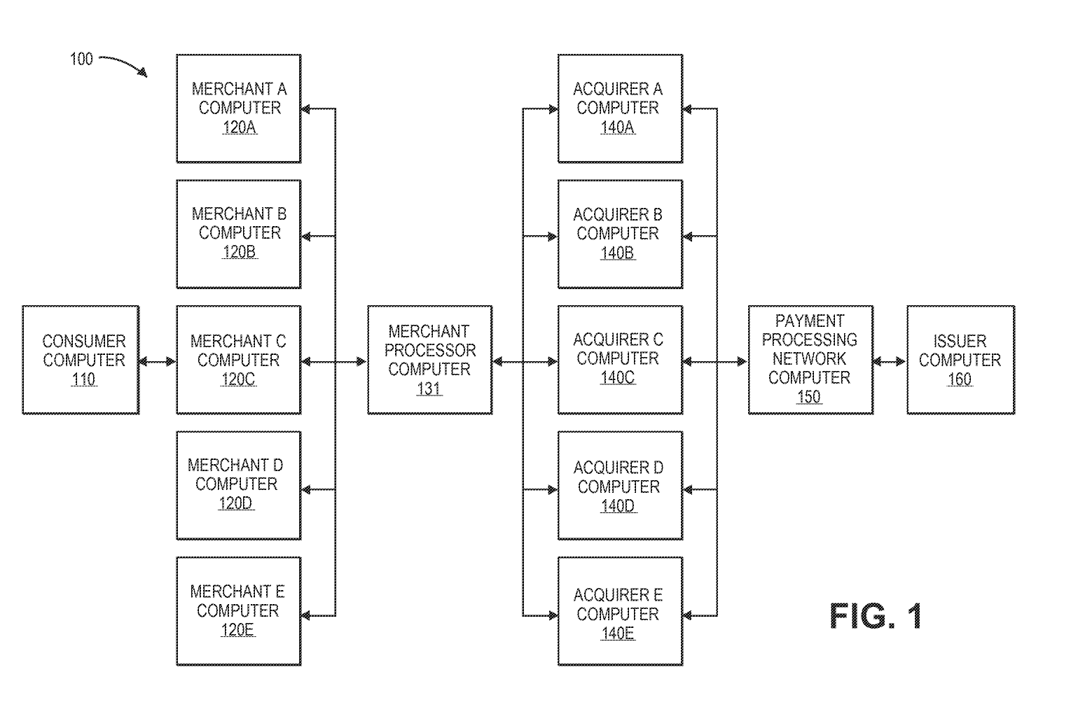

FIG. 1 shows a transaction system 100 according to one embodiment of the present invention. The transaction system 100 includes a consumer computer 110 communicating with multiple merchant computers 120A-120E. The merchant computers 120A-120E may communicate with or otherwise be electrically coupled to a merchant processor computer 131 so that merchant processor 130 has access to many transactions across a wide range of businesses, industries, and markets. The merchant processor computer 131 may be located between merchant computers 120A-120E and acquirer computers 140A-140E and may provide an extra barrier of fraud protection for merchants. A payment processing network computer 150 may further be coupled to the acquirer computers 140A-140E and an issuer computer 160 operated by an issuer associated with the consumer. Any of these entities may communicate with each other by relaying messages between each other. Furthermore, merchant computers 120A-120E, a merchant processor 130, acquirer computers 140A, a payment processing network computer 150, and an issuer computer 160 may all be in operative communication with each other (i.e., although not depicted in FIG. 1, one or more communication channels may exist between each of the entities, whether or not these channels are used in conducting a financial transaction).

The consumer computer 110 may include any device operated by a consumer that allows a consumer to communicate with a merchant 120C during a transaction. For example, the consumer computer 110 may include a portable consumer device, a desktop computer, a laptop, a smartphone, a portable electronic device, or any other device that may allow a consumer to communicate with a merchant. Additionally, the consumer computer 110 may also include a merchant access device that allows a consumer to enter credentials or payment account information and thus communicate with a merchant 130C through the merchant's access device. In such cases, the consumer may interact with the access device using a credit or debit card, a contactless consumer device, by entering credentials through an input interface of the access device, through voice or biometric identification, or through any other suitable means.

The merchant computers 120A-120E may include any computer, apparatus, device, or system associated with a merchant. For example, the merchant computer 120 may include a server computer that is operated by a merchant and allows consumers to place orders, initiate a service, or otherwise initiate transactions by communicating with the merchant server computer 120.

The merchant processor 130 may include any computer, apparatus, device, or system that may utilize information to determine the probability or likelihood that a transaction is fraudulent. Merchant processors may quantify the probabilities or likelihood of a fraudulent transaction by generating a risk score. In some embodiments, the merchant processor may approve, reject, monitor, or review a transaction before, during, or after a transaction authorization request message is generated for a transaction. In other embodiments, the merchant processor may merely provide a recommendation to a merchant to decline or reject a transaction.

The acquirer computers 140A-140E may include any computer, apparatus, device, or system associated with an acquirer. For example, the acquirer computers 140A-140E may comprise a server computer, coupled to a communications network that is configured to communicate with a merchant processor computer 130 and payment processing network computer 150.

The payment processing network may include data processing subsystems, networks, and operations used to support and deliver authorization services, exception file services, and clearing and settlement services. For example, the payment processing network may comprise a server computer, coupled to a communications network and a database(s) of information. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet. The payment processing network computer 150 may include any computer, apparatus, device, or system associated with a payment processing network.

The issuer computer 160 may include any computer, apparatus, device, or system associated with an issuer of a consumer's account. For example, the issuer computer 160 may comprise a server computer, coupled to a communications network that is configured to communicate with a payment processing network computer 150.

A typical credit card transaction flow using a payment device at an access device (e.g., point-of-sale (POS) location) can be described as follows (Note that embodiments of the invention are not limited to credit card transactions, but may also include other types of payment transactions including prepaid and debit transactions). A consumer may present his or her payment device to an access device (not shown) to pay for an item or service. The payment device (not shown) and the access device may interact such that information from the payment device (e.g., PAN, verification value(s), expiration date, etc.) is received by the access device (e.g., via contact or contactless interface). The merchant computer 120C may then receive the information from the access device. Alternatively, as shown in FIG. 1, in some embodiments, the merchant computer 120C may receive this information from the consumer computer 110 (e.g., during e-commerce transactions). The merchant computer 120C may then generate an authorization request message that includes the information received from the access device (i.e., information corresponding to the payment device or consumer account) along with additional transaction data (e.g., a transaction amount, merchant specific information, etc.) and electronically transmit this information to a merchant processor computer 131.

The merchant processor computer 131 may then perform a fraud evaluation as disclosed herein or through any other suitable method. The merchant processor computer 131 may determine a transaction decision for the transaction based on the fraud evaluation. The transaction decision may include actions such as, for example, approve, decline, review, or monitor the transaction.

Depending on the transaction decision of the transaction scorecard, the transaction may get passed onto the acquirer computer 140C (and subsequently the payment processing network computer 150 and issuer computer 160) by the merchant processor computer 131 if accepted, reviewed, or monitored. However, if the transaction is rejected, the transaction may not be passed onto the acquirer computer 140C or payment processing network computer 150. Instead, the merchant processor computer 131 may generate an authorization response message informing the merchant and the consumer that the transaction has been declined. Accordingly, in such embodiments, the transaction authorization request message is never passed into the typical transaction processing system including acquirers, payment processing networks, and issuers of typical transactions.

A transaction decision to review a transaction may include any action that allows the system to further review the transaction before making a decision to approve or reject the transaction. For example, the merchant processor computer may transfer the transaction data to an operator associated with the merchant processor in order to ensure the transaction is not fraudulent. The operator may be human or may include further inquiries by a computer program or system. For example, the review may include the sending of an authentication request message to the consumer's mobile device to authenticate the identity of the consumer or alert the consumer that their account was recently used in a transaction. As one of ordinary skill would recognize, any type of authentication may be implemented including challenge response authentication, the use of passwords or tokens, or any other suitable authentication schemes. Additionally, a second set of tests that test different attributes of the transaction may be implemented. For example, a second fraud evaluation may be initiated that uses a different fraud profile than the original fraud evaluation. Additionally, an investigation into other transactions in that geographic area, associated with the transaction account, associated with other family members of the account holder, or any other suitable investigation may be undertaken.

A transaction decision to monitor a transaction may include delaying or suspending the transaction to ensure that the account is not put on hold, suspended, or otherwise tied to suspicious activity before the account is run. Accordingly, the merchant processor may hold the transaction for a period of time to ensure the transaction is not fraudulent and may then try to reinitiate the transaction.

A transaction decision to approve a transaction may include forwarding the authorization request message to an acquirer computer 130C associated with the merchant 120C. The acquirer computer 140C may then receive, process, and forward the authorization request message to a payment processing network computer 150 for authorization.

In general, prior to the occurrence of a credit-card transaction, the payment processing network computer 150 has an established protocol with each issuer 160 on how the issuer's transactions are to be authorized. In some cases, such as when the transaction amount is below a threshold value, the payment processing network computer 150 may be configured to authorize the transaction based on information that it has about the consumer's account without generating and transmitting an authorization request message to the issuer computer 160. In other cases, such as when the transaction amount is above a threshold value, the payment processing network computer 150 may receive the authorization request message, determine the issuer associated with the consumer account, and forward the authorization request message for the transaction to the issuer computer 160 for verification and authorization. As part of the authorization process, the payment processing network computer 150 or the issuer computer 160 may analyze a verification value or other datum provided by the payment device, consumer computer, or other device associated with the consumer that initiated the transaction. The verification value may be stored at the issuer or the payment processing network. Once the transaction is authorized, the issuer computer 160 may generate an authorization response message (that may include an authorization code indicating the transaction is approved or declined) and transmit this electronic message to the payment processing network computer 150. The payment processing network computer 150 may then forward the authorization response message to the acquirer computer 140C, which in turn may transmit the electronic message comprising the authorization indication to the merchant computer 120C.

In embodiments where a consumer wishes to make an online purchase with a merchant over the Internet (i.e., e-commerce), a similar method as described above may be performed except that the merchant may use his consumer computer 110 or mobile device to provide information associated with a payment device (e.g., account number, consumer's name, expiration date, verification value, etc.) into respective fields on the merchant's checkout page (e.g., the merchant's server computer functions as an access device as described above). The consumer computer may provide this information to the merchant computer by communicating through the communications network. The rest of the process may be performed as explained above.

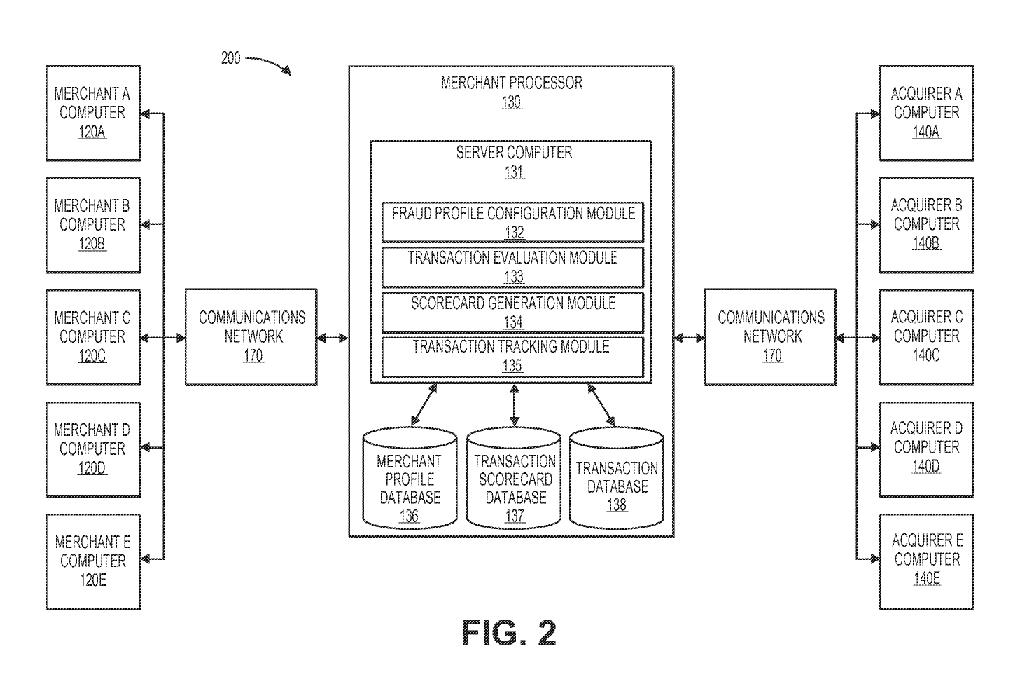

FIG. 2 shows a more detailed view of a merchant processor server computer 131 in a portion of a transaction system 200 according to one embodiment of the present invention. The merchant processor 130 may include a server computer 131 and multiple databases 136-138 coupled to the server computer 131.

The server computer 131 may comprise a fraud profile configuration module 132, a transaction evaluation module 133, a scorecard generation module 134, a transaction tracking module 135, and the server computer 131 may be coupled to a merchant profile database 136, transaction scorecard database 137, and a transaction database 138.

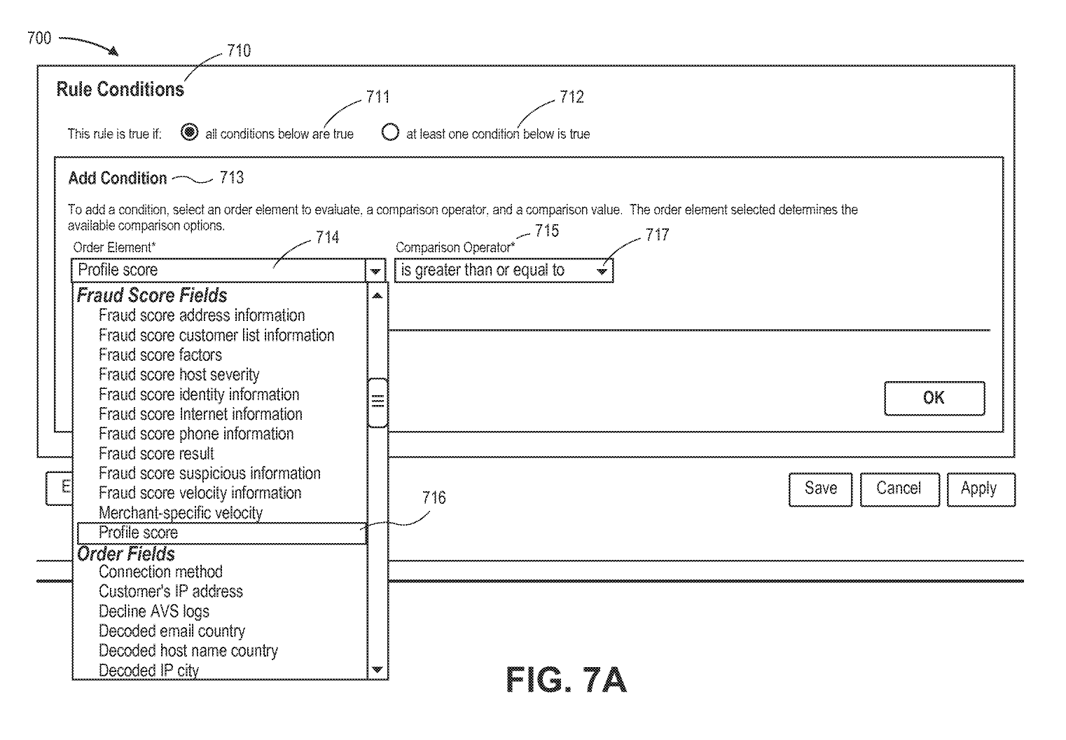

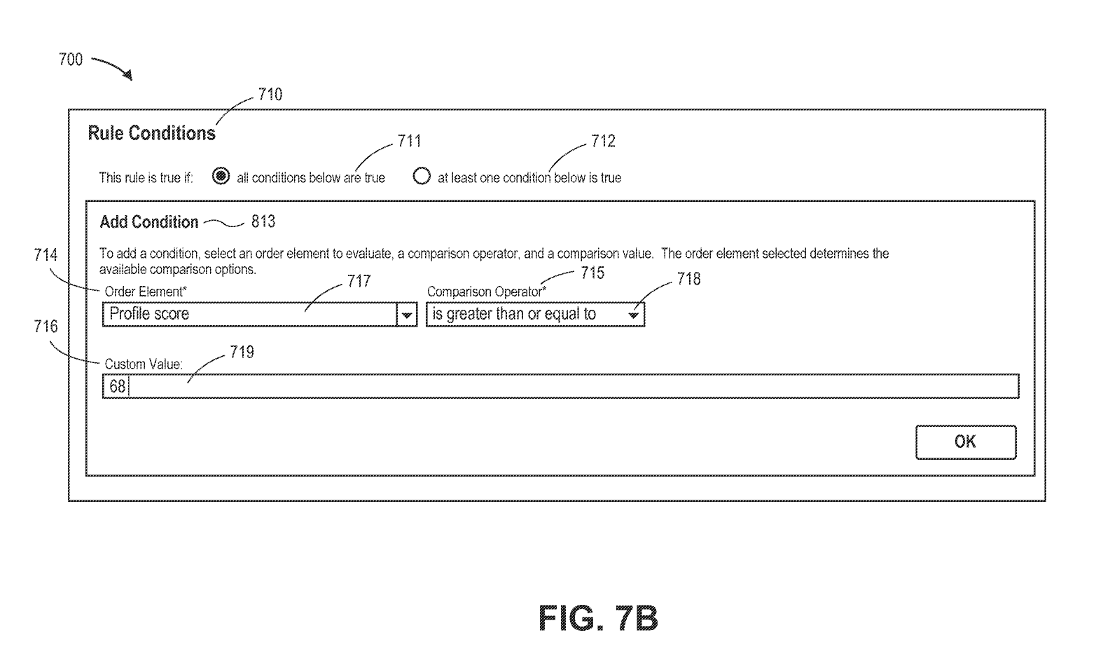

The fraud profile configuration module 132 may allow a merchant to customize a merchant profile to include the specific fraud rules, predetermined trigger scores for each fraud rule, transaction decision rules, and any other customizable information that may be implemented to configure a merchant profile. A merchant may configure their merchant profile by communicating with the fraud profile configuration module 132 of the merchant processor server computer 131 through a communications network 170. Exemplary figures showing exemplary graphical user interfaces for merchants configuring fraud profiles through the fraud profile configuration module 132 are shown in FIGS. 7-11, and are discussed in further detail below.

The communications network 170 may include any suitable network of hardware and/or software components to communicate messages between two entities. For example, the communications network may include communications using wireless or wired communications and may include networks such as the Internet, a wireless radio frequency (RF) communications network, a proprietary communications network (e.g., using a proprietary communications protocol), or any other communications network. As would be understood by one of ordinary skill in the art, any suitable communications protocol for storing, representing, and transmitting data between components in the system 100 may be used. Some examples of such methods may include utilizing predefined and static fields (such as in core TCP/IP protocols); “Field: Value” pairs (e.g. HTTP, FTP, SMTP, POP3, and SIP); an XML based format; and/or Tag-Length-Value format.

The transaction evaluation module 133 may include any software or hardware components that allow the merchant processor to complete a method of fraud evaluation as disclosed herein. For example, the transaction evaluation module 133 may comprise a computer-readable medium coupled to a processor, the computer-readable medium comprising code executable by the processor for performing a method of performing a fraud evaluation for a transaction as disclosed herein. The transaction evaluation module 133 may access and write information to and from the merchant profile database 136, transaction scorecard database 137, transaction database 138, and any other databases that may be implemented in the system.

The scorecard generation module 134 may include any software or hardware components that allow the merchant processor server computer 131 to generate, display, or present a transaction scorecard for a transaction as disclosed herein. For example, the scorecard generation module 134 may comprise a computer-readable medium coupled to a processor, the computer-readable medium comprising code executable by the processor for generating, displaying, or presenting a transaction scorecard generated for a transaction or stored in a transaction scorecard database 137. Additionally, the scorecard generation module 134 may be capable of storing a generated transaction scorecard in the transaction scorecard database 137 as well as sending or exporting a transaction scorecard to another system for display or presentation. For example, a merchant may have access to a transaction scorecard after a fraud evaluation of a transaction and the transaction scorecard generation module 134 may send the transaction scorecard to the merchant for display through the merchant computer 120A-120E. Alternatively, the transaction scorecard generation module 134 may generate transaction scorecards and store them on the transaction scorecard database 137 for later retrieval by or sending to a merchant computer 120A-120E. Furthermore, in some embodiments, the scorecard generation module 134 may present, display, or send the transaction scorecards when a particular transaction decision is determined (e.g., only when a transaction is rejected or declined) but may otherwise store the transaction scorecards in the transaction scorecard database 137 for a merchant's later review.

The transaction tracking module 135 may include any software or hardware components that allow the merchant processor server computer 131 to track the status of a transaction associated with a transaction scorecard over a period of time. For example, the transaction tracking module 135 may comprise a computer-readable medium coupled to a processor, the computer-readable medium comprising code executable by the processor for tracking the status of a transaction and updating the transaction scorecard with the status of the transaction if the status changes. Accordingly, the transaction tracking module 135 may communicate with a payment processing network computer 150, an issuer computer 160, or any other entity in the transaction system 100 to determine the present status of a transaction. The transaction tracking module 135 may manage, access, and update a transaction scorecard database 137 and a transaction database 138 at the merchant processor 130 to ensure the databases are accurately updated with the status of the transaction after the fraud evaluation is initiated and the transaction scorecard is generated by the scorecard generation module 134. For example, the transaction tracking module 135 may determine from a payment processing network computer 150, issuer computer 160, or merchant computer 120A-120E that the product associated with a transaction is returned, refused, or the transaction is claimed to be fraudulent by a consumer and the transaction tracking module 135 may update the transaction database 138 and the transaction scorecard stored in the transaction scorecard database 137 to indicate the final disposition or status of the transaction as refused, recharged, fraudulent, or comprising any other suitable status.

The merchant profile database 136 may include any memory, storage, or other data retaining element that may comprise merchant profiles including both the custom fraud models and hybrid fraud models described herein. As explained above, merchants may access these custom merchant profiles and configure their profiles through one or more graphical user interfaces that are described in further detail below. The merchant profiles may be stored and accessed through any suitable means including storing merchant profiles according to merchant identifiers, merchant codes, account numbers, passwords, or any other suitable means.

The transaction scorecard database 137 may include any memory, storage, or other data retaining element that may comprise transaction scorecards associated with transaction data stored in a transaction database 138. As explained above, the transaction scorecards may be sent, displayed, presented or otherwise shared with merchants through any suitable means. The transaction scorecards may be stored according to a merchant identifier, transaction data associated with the transaction (i.e., consumer name, merchant name, etc.), the transaction decision for the transaction, the merchant profile used to generate the transaction scorecard, or any other suitable method.

The transaction database 138 may include any memory, storage, or other data retaining element that may comprise transaction data associated with transactions received from merchant computers 120A-120E as described herein. The transaction data may be stored according to a transaction scorecard identifier or otherwise associated with a transaction scorecard that was generated based on the fraud evaluation. Additionally, the transaction database 138 may include any and all transaction data or payment data associated with a transaction including any information that may be used in a fraud evaluation as well as any information that may be used by a merchant to improve their custom fraud profiles. For example, the status of the transaction, the transaction decision, and any other information related to the fraud evaluation may be stored in the transaction database 138 along with the transaction data such that the merchant processor may evaluate the accuracy of a merchant profile in determining fraudulent transactions.

### II. EXEMPLARY METHODS

### A. Custom Merchant Scorecard

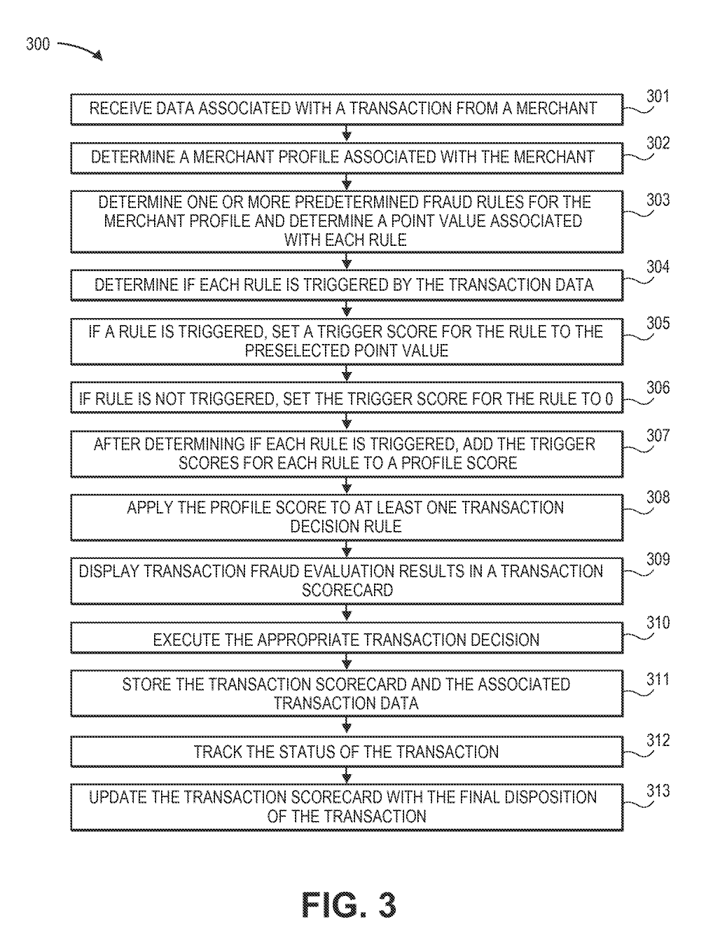

FIG. 3 shows a flow chart describing a method 300 of performing a fraud evaluation for a transaction including creating a transaction scorecard, according to one embodiment of the invention. A fraudulent transaction monitor service may be provided through a program operating on the merchant's server computer, through an application program accessed through an internet connection between the merchant and the merchant processor, through a series of messages sent back and forth from the merchant processor and the merchant, or any other suitable method. Preferably the merchant may access a program, web page, or any other suitable hardware or software element that communicates with a merchant processor where the merchant can configure their profile, customize rules, and gain access to results of the fraudulent transaction monitor service on transactions.

In step 301, a transaction evaluation module of a merchant processor receives a transaction authorization request message or otherwise receives transaction data associated with a transaction initiated at or by a merchant.

In step 302, the transaction evaluation module of the merchant processor determines a merchant profile associated with the merchant. The merchant processor may determine the merchant profile based on a registered merchant identifier, through other information contained in the transaction data, or through any other suitable method.

In step 303, the transaction evaluation module of the merchant processor determines one or more predetermined fraud rules for the merchant profile. The merchant may have previously selected predefined rules or created merchant defined rules into a custom merchant profile using a fraud profile configuration module of the merchant processor. The rules may be based on any transaction data or payment data including account number, BIN number, time, location, type of product being used, frequency of transactions, etc. For example, based on the information that transactions occurring between 2 am and 6 am have a higher chance of fraud than transactions made during other times and as such, a rule may state that any transactions made during that time may be monitored before being accepted. Another example may include that any transaction that occurs more than 100 miles from the billing address of the account holder may be rejected or reviewed. There can be any number of rules loaded into the merchant profile. The rules may be organized in any order preferred by the merchant. The merchant can be provided with a list of typical rules provided by the merchant processor through the fraud profile configuration module or the merchant may be provided with a custom rule toolbox where they can create their own rule based on the specific needs of their business. Any combination of custom or pre-defined rules can be selected by the merchant.

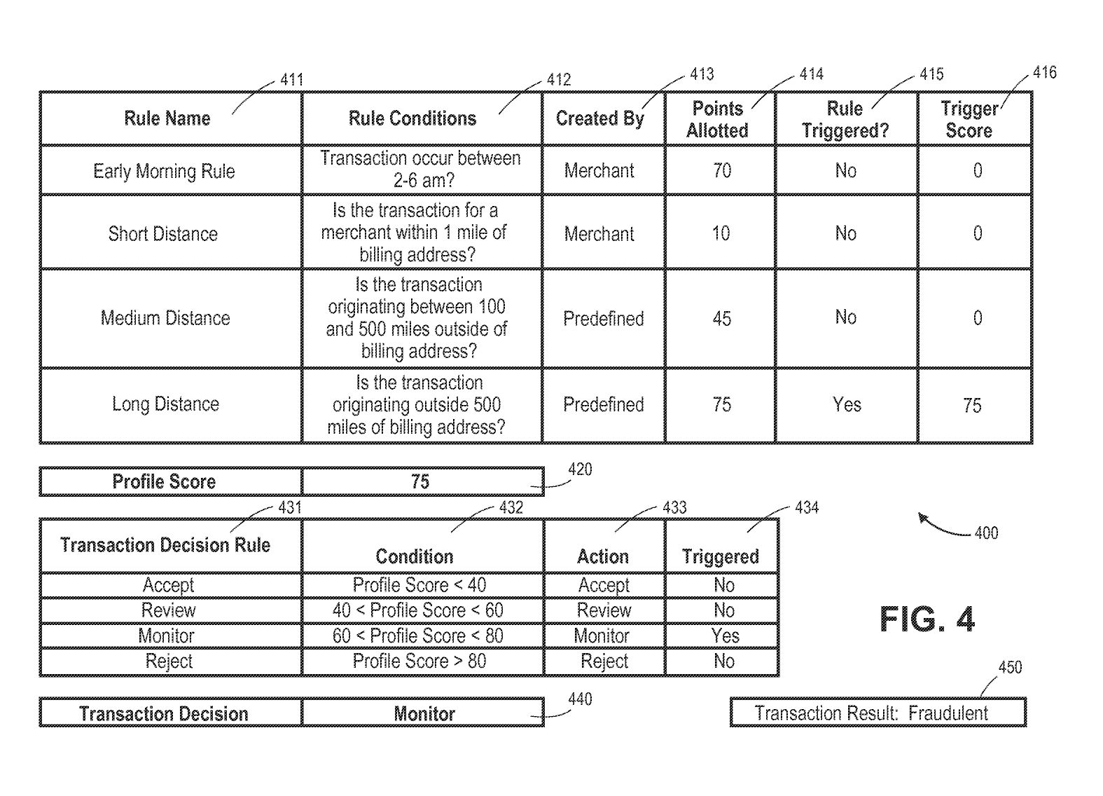

Additionally, each rule may have been assigned a point value by the merchant. Accordingly, the merchant processor may determine a point value associated with each rule. This preselected point value is the score that may be assigned if the rule is triggered by the transaction data (i.e., trigger score). The point values effectively replace the transaction action that was originally associated with the rule. By setting the point value for each rule, the merchant can be given custom control over the weighting or impact that each rule has on a transaction fraud decision when it is triggered. For example, if the merchant determines that transactions that occur 500 miles away from the billing address of the cardholder have a 98% chance of being fraudulent, the merchant can weight this rule with a very large number of points so that if the transaction triggers this rule, the transaction may most likely be rejected, reviewed, or monitored. In this case, the rule could be given a score of 75 and a transaction decision rule could be set such that any score over 80 may be reviewed. As such, the rule is weighted such that it has a large impact on whether a transaction is accepted, reviewed, or rejected. As shown in FIG. 4, which shows a transaction scorecard 400 which implements the above example, if anything else is suspicious about the transaction, the transaction may be rejected and if no other rules are triggered, the transaction may be monitored. Accordingly, the single rule has a large impact on the transaction decision for the transaction but may provide more flexibility than a single action based on a triggered rule.

Furthermore, if a rule has a very low correlation to whether a transaction is fraudulent, it may be given a small number of points. For example, a rule related to whether a transaction occurs over the internet or in person may be given a score of 10 if triggered. In this case, if both a transaction originated from 500 miles away and over the internet, the transaction may be rejected, reviewed, or monitored but if either rule was not triggered, the transaction may not be reviewed. One can see how the predetermined rules could be set such that a merchant can customize their fraud profile to the intricacies of their business. One of ordinary skill in the art would appreciate how the scoring schemes can be reversed such that it is possible that negative points are assigned or the scoring scheme be edited such that lower points indicate fraud instead of higher points in the above example.

Additionally, if a rule has an impact on a transaction such that it tends to prove a transaction is not fraudulent, a point value could be assigned to represent a rule's known positive or non-fraudulent impact. These rules could help offset what could otherwise be interpreted as a risky transaction. For example, a rule could be assigned a preselected point value of −10 points such that if the rule is triggered, the rule helps to lower the profile score for the transaction and thus, increase the chance that a transaction may be accepted.

In step 304, the transaction evaluation module of the merchant processor may determine if each rule is triggered by the transaction data associated with a transaction. The merchant processor may apply the fraud rules of the determined merchant profile to the transaction data to determine if each and every rule is triggered. A rule being triggered may mean that the transaction data meets the condition of the rule. For example, a transaction originating 500 miles from the cardholder's billing address may trigger a conditional rule stating the rule may trigger for any transactions originating more than 100 miles from the cardholder's billing address.

Traditionally, fraud rules may have transaction decisions built into them, for example, the conditional rule that may be triggered by the transaction originating more than 100 miles from the cardholder's billing address may automatically cause the transaction to be reviewed, monitored, or declined. However, these fraud rules may be too broad for all merchants and the single rule transaction decision triggering may lead to consumer annoyance and inaccurate identification of fraudulent transactions. Accordingly, the custom merchant profile replaces the transaction decision of a rule with a point system that may use multiple rules to determine a transaction decision. Accordingly, more flexibility, customization, and more data input may be used to determine a transaction decision for a particular transaction. For example, instead of the above rule automatically meaning a transaction is rejected, the rule could be given a trigger score of 75. Depending on the transaction decision rules, the trigger score may lead to a rejection or may lead to another decision depending on whether other rules are triggered. For instance, some merchants may have positive rules that indicate that a transaction is legitimate even if other alarming conditions are present. Accordingly, in previous systems the transaction would have automatically been rejected or reviewed when the 100 mile fraud rule was triggered but present embodiments of the invention may allow such transactions to be accepted without review based on other factors or triggered rules.

In step 305, if a rule is triggered, the transaction evaluation module of the merchant processor server computer determines a trigger score equal to the assigned point value for that rule. A trigger score is the score of the rule when it is triggered. As explained above, when the conditions of a rule are met, a trigger score for that rule is determined by setting the trigger score equal to the preselected point value set provided by the merchant for that rule.

In step 306, if a rule is not triggered, the transaction evaluation module of the merchant processor server computer determines a trigger score of 0 (zero) for that rule. As explained above, not all rules may be triggered for any given transaction because the rule conditions may not be met. If the transaction data does not trigger the condition of a rule, a trigger score of 0 may be assigned for that rule so that the untriggered rule may not have an effect on a transaction decision. For example, if a transaction occurs 1 mile from a cardholders billing address, the rule conditioned on a cardholder being more than 100 miles from home may not be triggered and a trigger score of 0 may be assigned for that rule. Accordingly, the risk of the transaction being fraudulent is not affected by the 100 mile distance fraud rule and as such, the rule should not have an effect on the transaction decision. In some embodiments, based on the custom scoring scheme of a merchant's custom merchant profile, some points could be provided for rules that do not trigger. For example, if a rule is strongly correlated with fraud and the lack of the rule being triggered tends to show that the transaction is not fraudulent, the trigger score for a rule that is not triggered could be other than 0 (e.g., negative points could be awarded to positively affect the chances of approval for the transaction).

In step 307, after determining if each rule is triggered, the transaction evaluation module of the merchant processor server computer adds the determined scores for each rule to determine a profile score. Once all the rules have been run and each rule has a determined trigger score, the trigger scores of all the rules are added to determine a merchant profile score. As explained in the example above, the triggering of the two rules related to distance from the cardholders billing address and the transaction occurring online may equal 75 points. If these were the only rules triggered by the transaction data for a merchant profile, the merchant profile score may be 75. However, a merchant profile score may also start at a predetermined value. For example, every transaction could start with a merchant profile score of 20 before any rules are triggered.

In step 308, the transaction evaluation module of the merchant processor applies the profile score to at least one transaction decision rule. The one or more transaction decision rules may be part of the merchant profile determined in step 303 described above. Depending on the profile score determined by the rules, a transaction decision may be made as to whether the transaction may be accepted, monitored, reviewed, or rejected. As explained in the example above, the profile score is applied to the transaction decision rules and a final decision is made based on the profile score.

According to some embodiments of the present invention, a merchant may use the fraud profile configuration module of the merchant processor to configure one or more transaction decision rules to apply to the custom merchant profile score. These rules may be conditional as well in that the rules may trigger or not depending on whether the merchant profile score met the conditions of the one or more rules. For example, as shown in FIG. 4, a set of transaction decision rules 431 could have the conditions 432 and actions 433 such that if a merchant profile score is less than 40, the transaction may be accepted and if the score is between 40 and 60, the transaction may be monitored before being accepted. Furthermore, if the profile score is between 60 and 80, the transaction may be reviewed prior to allowance. Finally, if the profile score is between 80 and 100, the transaction may be rejected without any review. In the above example, if the merchant profile score 420 for a transaction is 50, the transaction may be monitored by a merchant processor or merchant prior to allowance.

Furthermore, the transaction decision rules 431 can include other conditions 432 outside of the profile score (not shown). For example, using the transaction decision rules explained above, a transaction decision rule could be set such that if the profile score is between 40 and 60 and the transaction is originated in Russia, the transaction may be rejected (instead of monitored as other profile scores between 40 and 60 originated elsewhere).

In step 309, the merchant scorecard generation module of the merchant processor server computer may display the transaction results in a transaction scorecard for the merchant's review. After the fraud evaluation of the transaction has been completed and a transaction decision has been determined, the transaction results may be displayed for the review of the merchant. However, the review of the transaction scorecard is not required prior to the transaction being sent to be authorized by an acquirer computer, payment processing network computer, or issuer computer as described above. However, the scorecard can be displayed for a merchant if they wish to review transaction scorecards in real time or if the merchant would like to review the transaction scorecard at a later time.

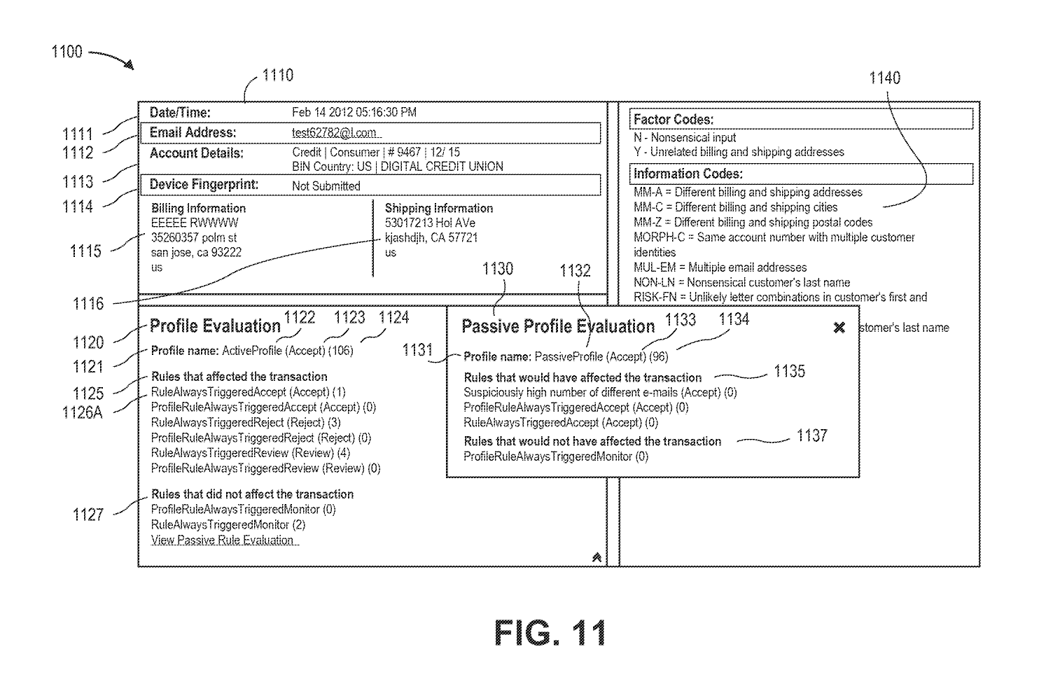

FIG. 4 shows a transaction scorecard 400 according to one embodiment of the present invention. The transaction scorecard 400 shows the transaction evaluation results in a table format. However, other display formats are possible. For example, FIG. 11 shows an alternative embodiment of the transaction scorecard 1100 that may be discussed further below. Additionally, statistics for trigger rate, trigger accuracy, etc., providing the merchant information related to the efficiency and effectiveness of the profile score can be added to the transaction scorecard (not shown).

The transaction scorecard 400 may comprise the transaction evaluation results for the transaction. As shown in FIG. 4, transaction evaluation results may include the names of the preselected rules 411 and the transaction decision rules 431, the conditions of the predetermined rules 412 and the transaction decision rules 432, who created the preselected rules 413 and transaction decision rules (not shown), the points allocated 414 to the preselected rules, whether the preselected rules were triggered 415 by the transaction data, the trigger scores 416 for the preselected rules, the merchant profile score 420, whether the transaction decision rules were triggered 434, the transaction decision determined by the profile score 440, the status or final disposition of the transaction 450 (if a period of time has occurred since the initiation of the transaction), and any other data that can be determined from the transaction data and the preselected rules 411. For example, as shown in FIG. 11, transaction data 1110 may also be shown such as the originating location, personal details of the transaction originator 1112-1113 and 1115-1116, date and time of the transaction 1111, etc. Additionally, the transaction results can also include statistical information related to the transaction decision and historical results of similar or all transactions (not shown).

Additionally, one of ordinary skill in the art may recognize that the transaction scorecard 400 may be generated and/or displayed at any time during the fraud evaluation process or at many times during the fraud evaluation process. For example, the results of each preselected rule 411 may be displayed in a transaction scorecard 400 after each rule 411 is determined to be triggered or not 415. Accordingly, the transaction scorecard 400 can be incrementally completed or all the results can be displayed in a transaction scorecard 400 at the same time once all the rules have been completed.

Returning to the flow chart of FIG. 3, in step 310 the merchant processor may execute the appropriate or determined transaction decision. For example, using the transaction scorecard presented in FIG. 4, the merchant processor may execute a monitoring action 440 for the transaction. The monitoring transaction decision 440 may include pausing, delaying, or otherwise waiting to process the transaction until a certain period of time to determine if the account or associated consumer behavior provides more insight into whether the transaction is fraudulent. However, for other transactions, an accept (i.e., approve) action may be executed by the merchant processor generating or forwarding an authorization request message to be sent to the appropriate acquirer computer, payment processing network computer, and/or issuer computer for transaction processing and authorization. Alternatively, if the transaction decision is to reject (i.e., decline) the transaction, the merchant processor may generate an authorization response message and send the response to the merchant and subsequently the consumer to end the transaction.

If the transaction decision is to review or monitor the transaction, any number of steps can be executed by the merchant processor or any other entity in the transaction processing system. For instance, the transaction data can be sent to a human to review the data, transaction data can be sent to another system for further processing, or further processing can be delayed until the transaction data can be reviewed and accepted at a later time. Any other system can be used to monitor or review the transaction and the merchant processor, merchant, or any other entity in the transaction system may take the further steps of review and monitoring by any means that may be recognized by one familiar with such techniques.

As discussed above, the steps related to displaying the results in a hybrid transaction scorecard, storing the results, and executing the appropriate transaction decision could be implemented in any order. Additionally, the one or more processors can allow automatic acceptance and/or rejection when a threshold profile score is reached prior to determining whether all the rules are triggered. Furthermore, the transaction decision rules could be configured in such a way that an exception rule be set such that if a condition exists at any time during the triggering of the rules, an action occurs. However, the profile score may always be fully generated and stored regardless of whether the transaction executes prior to determining whether each and every rule is triggered. This data may be saved for later review and analysis. As such, no matter when the transaction decision is executed, a complete profile score for the transaction may be calculated.

In step 311, the transaction scorecard and the associated transaction data may be stored. After all the rules are compared to the transaction data, all of the information contained in the transaction results is stored on a database such that the results can be reviewed and analyzed at a later time. This information includes which rules triggered, why the rules triggered, what the final transaction decision was, the profile score for the predetermined rules, etc. Similar to step 308, this step can occur in any order. Additionally, even if the transaction results are not displayed or no transaction decision is actually executed, the data may be stored for later review and analysis (.e.g., a passive profile may be evaluated but not used in a transaction evaluation fraud analysis).

In step 312, the transaction tracking module may track the status of the transaction. The status of the transaction may be tracked through any suitable method including the merchant processor may update the status of the transaction every time any information is received that is associated with the transaction. For example, the indication in the authorization response message may be updated for the transaction when the authorization response message is received from the acquirer. Furthermore, in some embodiments, the payment processing network may update the merchant processor with the status of the transaction if a refund, recharge, or other action occurs that indicates some fraud or updated status for the transaction. Once the transaction is approved, the transaction may have a status of legitimate and may only change when new information is received regarding the transaction.

In step 313, the transaction tracking module may update the transaction scorecard with the final disposition of the transaction. As shown in FIG. 4, the transaction scorecard 400 may indicate the status 450 or ultimate disposition of the transaction. For example, the status of the transaction shown in FIG. 4 is marked as fraudulent because the transaction decision 440 was to monitor the transaction and after being monitored, an operator determined that the transaction was fraudulent. This information may be updated in a transaction database and/or transaction scorecard database and may be used at a later time to determine the accuracy of the custom merchant profile and/or other profiles (e.g., multiple merchant profile) and to further develop additional fraud rules.

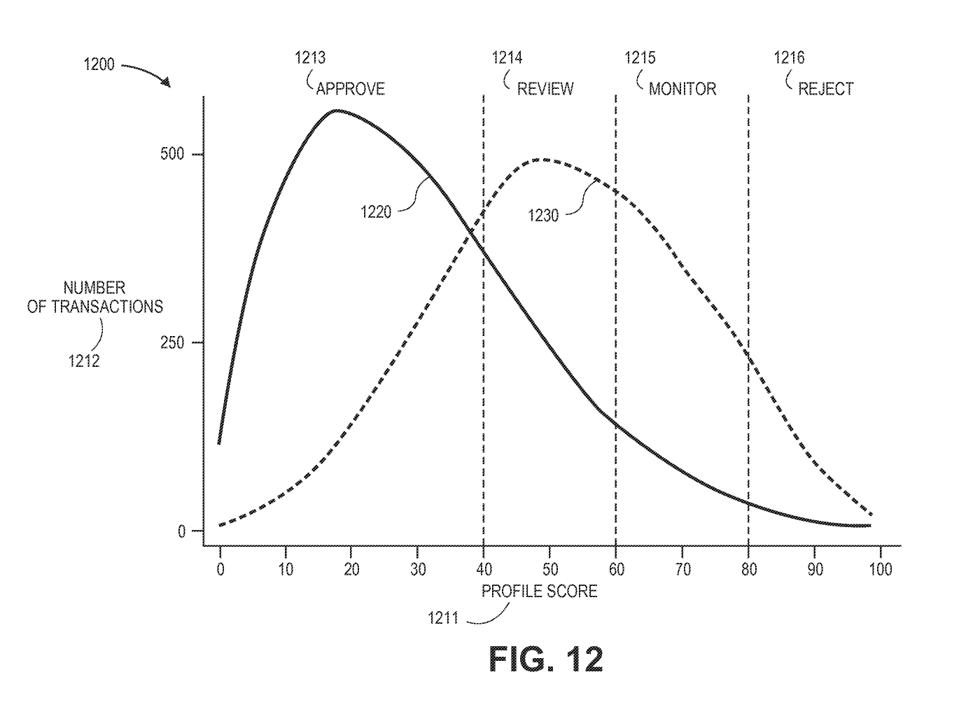

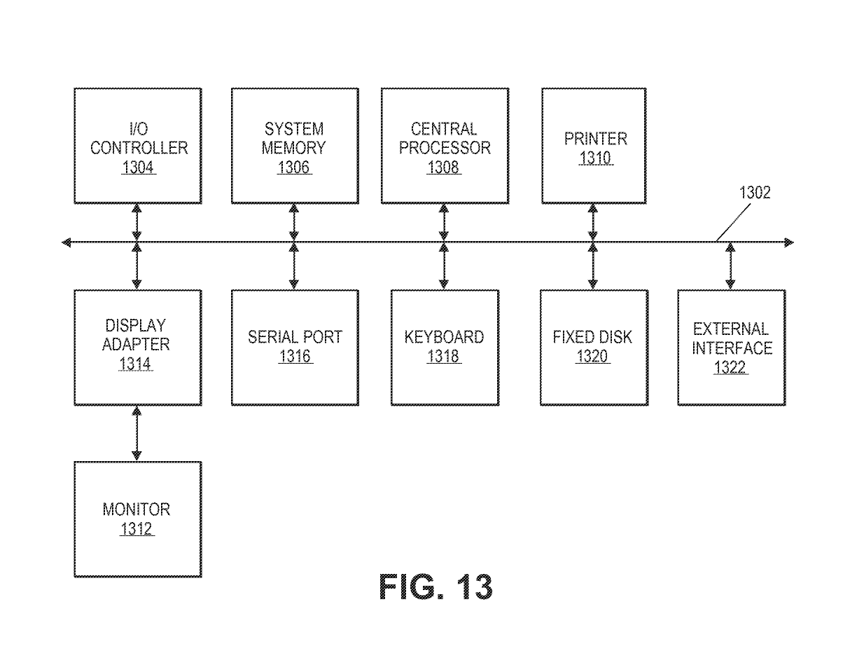

Additionally, the transaction scorecard may be interactive, such that the transaction scorecard allows a merchant to request another fraud evaluation for the transaction using updated trigger scores 416, preselected rules 411, and transaction decision rules 431. The updated transaction scorecard may or may not be used in the process of executing the transaction. Either way, the scorecard may be updated or run with a second profile to show the difference that the updated profile would have had on the transaction. Further explanation of the additional fraud evaluation and data mining is provided below regarding FIGS. 11 and 12.

Although steps of the above described exemplary embodiment are described as being performed by particular modules and entities within the transaction processing system, one of ordinary skill would recognize that other suitable configurations, entities, and processes may be implemented in line with the above description.

### B. Hybrid Scorecard

Another embodiment of the present invention is directed to a hybrid fraud model that may be implemented to customize a merchant fraud profile without relying entirely on a merchant's custom merchant profile. The hybrid transaction scorecard combines a centralized multiple merchant fraud model and a customized merchant fraud model to a produce a hybrid model. The multiple merchant fraud model may be provided by a merchant processor that has access to transaction data from a large number of merchants. The respective scores of the centralized multiple merchant fraud model and the customized merchant model may be weighted for further customization. The hybrid model produces a hybrid profile score that is a combination of the other model scores. The hybrid profile score may be used in the same manner as the single custom merchant profile score described above. Additionally, the individual scores could be used to provide further customization of the fraud profile and transaction decision rules. The hybrid fraud profile allows a merchant to build on the collective wisdom of multiple merchants but also tailor results to their specific business, clients, or industry.

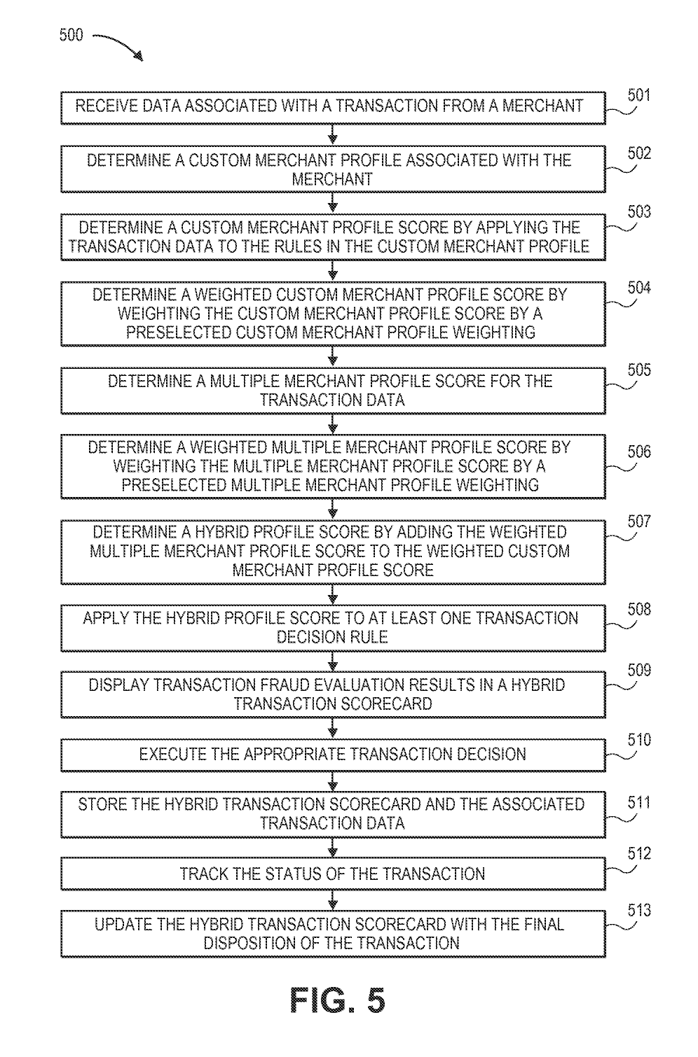

FIG. 5 shows a flow chart describing a method of creating a hybrid transaction scorecard 500 according to one embodiment of the invention. The hybrid transaction scorecard may preferably look similar to the transaction scorecard described above in reference to FIGS. 3 and 4 using a customized merchant profile model but may include a multiple merchant profile score that has the ability to be weighted for custom results. The custom merchant profile score discussed in FIG. 3 could also be weighted to further allow the customization of the results. The weighted custom merchant profile score may then be added to the weighted multiple merchant profile score to determine a hybrid profile score.

In steps 501 and 502, just as in the process above regarding FIG. 3, the merchant processor may receive data associated with a transaction from a merchant and may determine a custom merchant profile associated with the merchant.

In step 503, the merchant processor determines a custom merchant profile score by applying the transaction data to the rules in the custom merchant profile. This process is the same as that explained above regarding FIG. 3. The custom merchant profile may be the same profile as that described above but the scores may change now that a weighted multiple merchant profile score is going to be added as well. However, the merchant may also be given an opportunity to set a preselected multiple merchant profile weighting to weight the custom merchant profile score as well. Therefore, the score may be the same as in a transaction scorecard that does not implement a multiple merchant profile score and the merchant may merely change the weighting to be applied to the custom merchant profile weighting.

In step 504, the transaction evaluation module of the merchant processor may determine a weighted custom merchant profile score by weighting the custom merchant profile score by a preselected custom merchant profile weighting. The preselected custom merchant profile weighting may be stored in the custom merchant profile and may be applied to the custom merchant profile to determine the new transaction amount.

In step 505, the transaction evaluation module of the merchant processor may determine a multiple merchant profile score. The multiple merchant profile score may be determined using the same process as described above in regards to the custom merchant profile but the transaction evaluation module may use a multiple merchant profile that is based on millions and billions of transactions that the merchant processor is privy to during a year for all of the merchants that the merchant processor services. Accordingly, the rules that determine the multiple merchant profile score may be loaded into the merchant's profile and the rules may be run similar to the custom merchant profile score explained above or a separate merchant profile score may be determined and imported into the hybrid merchant scorecard for the transaction. Either way, the merchant processor may provide the predetermined rules or the score to the transaction scorecard.

In step 506, the transaction evaluation module of the merchant processor may determine a weighted multiple merchant profile score by weighting the multiple merchant profile score by a preselected multiple merchant profile weighting. The weighting of the custom merchant profile and the multiple merchant profile can be combined to make an overall weighting of 1 such that a typical score can be obtained or can be implemented to result in more or less than a typical score (i.e. one weighting at 1.5× and the other at 2× a typical score). The hybrid transaction evaluation system may be flexible and may allow the merchant to customize the scoring as they desire.

In step 507, the fraud monitor service determines a hybrid profile score by adding the weighted multiple merchant profile score to the weighted custom merchant profile score. If no weighting has been set, the weightings may be preset for a weighting of 1 (i.e. no weighting).

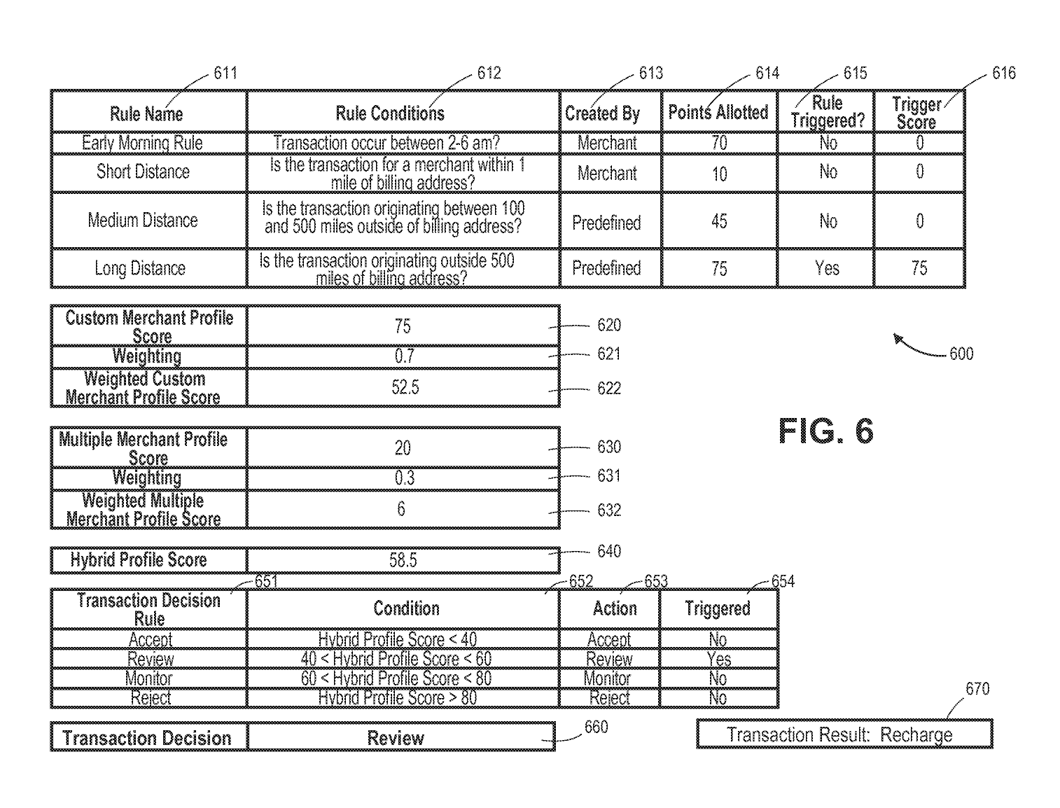

In step 508, the transaction evaluation module of the merchant processor may apply the hybrid profile score to at least one transaction decision rule. As can be seen in FIG. 6, the hybrid profile score 640 may determine a different transaction decision than the custom merchant profile transaction scorecard 400 shown in FIG. 4 based on the same transaction data due to the weighting and combination of two different profile scores 620, 630. Additionally, the transaction decision rules 651 may be much more complicated because the weighted custom merchant profile score 622 and the weighted multiple merchant profile score 632 could be used in the transaction decision rule conditions 652 as well as the hybrid profile score 640. For example, a transaction decision rule could be dependent on both the custom merchant profile score 620 and the hybrid score 640 separately. Any number of rules could be implemented to further customize the control of the hybrid scorecard model by the merchant.

FIG. 6 shows a hybrid transaction scorecard 600 according to one embodiment of the present invention. The hybrid transaction scorecard 600 includes all the information of the transaction scorecard 600 above but also includes the profile score 620, 630, weighting coefficients 621, 631, and weighted profile scores 622, 632 for the custom merchant profile score 620 as well as the multiple merchant profile score 630.

In step 509, the merchant scorecard generation module of the merchant processor may display the transaction results in a hybrid transaction scorecard. As described above, the transaction results may be displayed in any suitable format and any and all available information may be displayed. FIG. 6 shows an example of one possible embodiment of the hybrid transaction scorecard 600. The scorecard 600 may show the weightings 621, 631, all three of the profile scores (custom merchant 620, multiple merchant 630, and hybrid 640), the trigger scores 616, transaction decision rules 651, etc. The transaction results can also include statistical information related to the transaction decision and historical results of similar transactions (not shown). Furthermore, information could be provided of what the transaction decision may have been if the hybrid profile score 640 were not used and the multiple merchant profile score 630 or the custom merchant profile score 620 were used instead. As such, a head-to-head comparison of the custom merchant profile score 620 and the multiple merchant profile score 630 over one transaction or a history of transactions (e.g., see FIG. 12) may be obtained for easy and accurate comparison for accuracy and further rule development. Any other transaction results that can be determined from the transaction data may also be displayed as one familiar in the art may appreciate.

Steps 510-513 are described above in reference to FIGS. 3 and 4. The same process as above is implemented by the hybrid profile and transaction scorecard process.

### C. Generating Custom Merchant Profiles

FIGS. 7-11 show screenshots of exemplary graphical user interfaces for a merchant or other user to generate, customize, and interact with a custom merchant profile and hybrid merchant profile. In some embodiments of the present invention a custom merchant profile may be generated by a merchant through interaction with the fraud profile configuration module of the merchant processor. A method of generating a custom merchant profile may include a merchant generating a custom merchant profile score rule, selecting a plurality of merchant rules, and generating a transaction decision rule.

The step of selecting a plurality of merchant rules may include selecting a merchant rule from a plurality of predetermined rules and generating a custom merchant rule. Generating a custom merchant rule may further include selecting a condition associated with transaction data and selecting a trigger score. The step of generating a transaction decision rule may further include selecting an initial score, selecting a transaction decision, selecting the custom merchant profile score rule, and selecting a priority for the transaction decision.

FIG. 7A shows an exemplary graphical user interface 700 for a merchant user to generate a custom merchant profile rule for use with embodiments of the present invention. The merchant may contact a merchant processor using a merchant computer and may log in or otherwise provide their credentials to ensure they are authorized to configure the merchant profile. The merchant may then request that they create a new custom profile rule. A merchant may generate custom profile rules based on any rule conditions 710 associated with any order element or transaction data associated with a merchant, consumer, product, manufacturer, issuer, etc. related to a transaction. For example, as shown in FIG. 7A, a rule may be conditional on an order element 714 related to a fraud score evaluation including a profile score 716, address information, customer list information, fraud factors, velocity, identity information, etc. The merchant may choose any of the order elements to make the rule or profile conditional on. In this example, the merchant determines that the rule should be conditional on a profile score 716 because the merchant is generating a custom merchant profile score rule. Accordingly, the custom merchant profile rule is conditional a profile score 716.

The custom merchant profile score rule may be a combination of multiple custom or selected fraud conditions. A conditional statement may allow a merchant to select that the custom merchant profile score rule may be conditional on all of the selected conditional elements being met 711 or on at least one condition being met 712. Accordingly, any number of different conditions may be placed in a single merchant profile score rule including multiple complex rules based on a number of different elements. Alternatively, simple rules and simple profiles may be generated based on single conditions. Accordingly, the complexity of the rules and profiles are customizable by the merchant. Additionally, a comparison operator 715 may be used to change or customize the trigger condition for the order element 714. Numerous options may be provided for both the order elements 714 (as shown) and the comparison operator 715 (not shown) in drop down lists or any other suitable method for presenting options to the merchant.

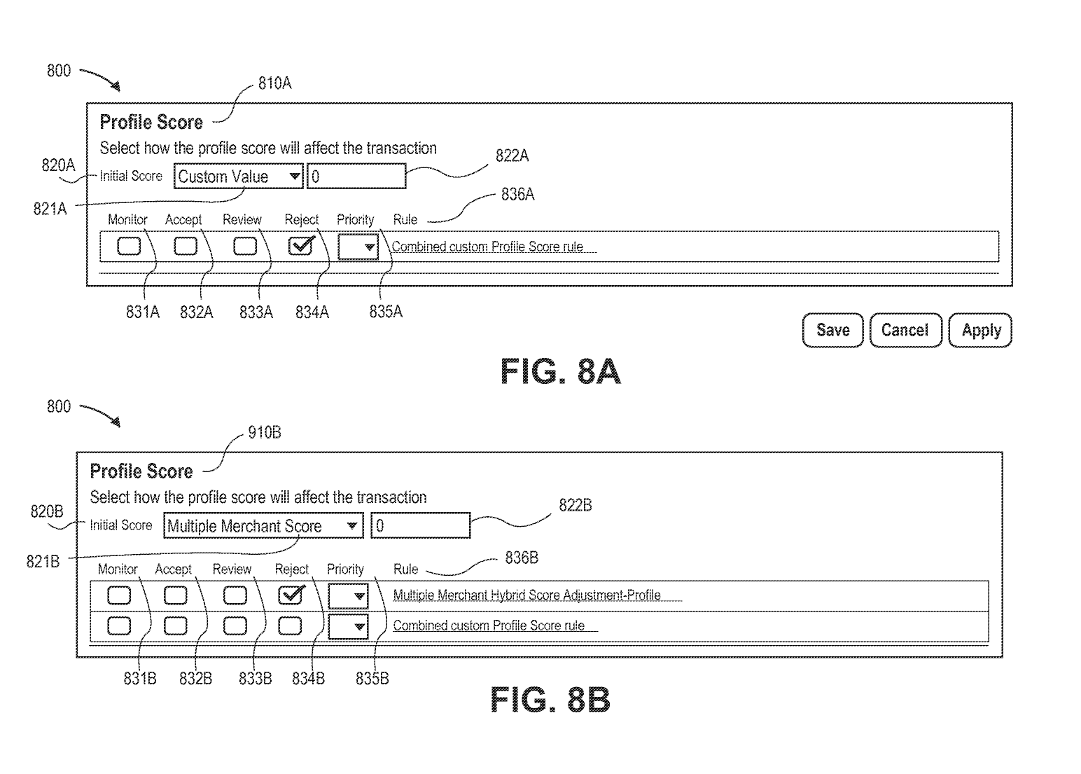

FIG. 7B shows the exemplary graphical user interface 700 for a merchant to generate a custom merchant profile, after the merchant has selected the profile score 716 as an order element 714, greater than or equal to 717 as the comparison operator 715, and is prompted to enter a comparison value (custom value) 716. In the provided example, the merchant has entered a comparison value of 68 for the condition trigger operation. Accordingly, the merchant profile rule may be ready to be used in a transaction decision rule. For example, the rule shown in FIG. 7B may include a trigger condition that may trigger when a profile score is greater than or equal to a comparison value of 68. The graphical user interface that may be used to set the transaction decision for the profile rule may be provided in FIGS. 8A-8B.

FIGS. 8A and 8B show exemplary graphical user interfaces for a merchant to set a transaction decision rule using the predetermined merchant profile score rule sets in FIGS. 7A-7B above. The profile score window 810A, 810B may allow a merchant to set how the profile score rule may affect the transaction to monitor 831A-B, accept 832A-B, review 833A-B, reject 834A-B, or otherwise determine a transaction decision for a profile score rule. For example, in FIG. 8A, the custom merchant profile score is set to an initial value (i.e., initial score) 820A of 0 and is set to reject 834A the transaction if the custom merchant profile score rule 836A titled “Combined Custom Profile Score” is triggered. The transaction decisions 831A-834A may be set by checking the box corresponding to the custom merchant profile score rule 836A, as shown. Typically, only one transaction decision may be set for each custom merchant profile score rule 836A. It may be possible in some embodiments to set two transaction decisions for important rules, for example, setting both a monitor 831A and review 833A transaction decision for a single custom merchant profile score rule.

FIG. 8B shows a profile score window for a hybrid fraud profile embodiment. The multiple merchant score 821B is selected as the initial score that the profile score is based on. This is another embodiment for determining a hybrid score that is different from the method described in FIGS. 5-6. In this hybrid profile, the profile score is based on the initial multiple merchant profile score 821B and instead of weighting a custom merchant profile score and a multiple merchant score, the multiple merchant score is used as an initial score 820B with one or more additional custom merchant rules and custom merchant profile score rules used to customize the multiple merchant score. For example, the multiple merchant score 821B may return a score of 70 for a transaction. However, the merchant may create or select a custom merchant profile score rule 836B based on the multiple merchant score that then alters this multiple merchant score 821B by evaluating additional rules with individual trigger scores that may change this multiple merchant score 821B. Accordingly, no weighting occurs but the multiple merchant score 821B is used as a baseline starting point to further alter or customize the fraud evaluation. Accordingly, the merchant may generate custom merchant profiles that are based on the multiple merchant score 821B but may further customize the multiple merchant score 821B to conform to the intricacies of their business.

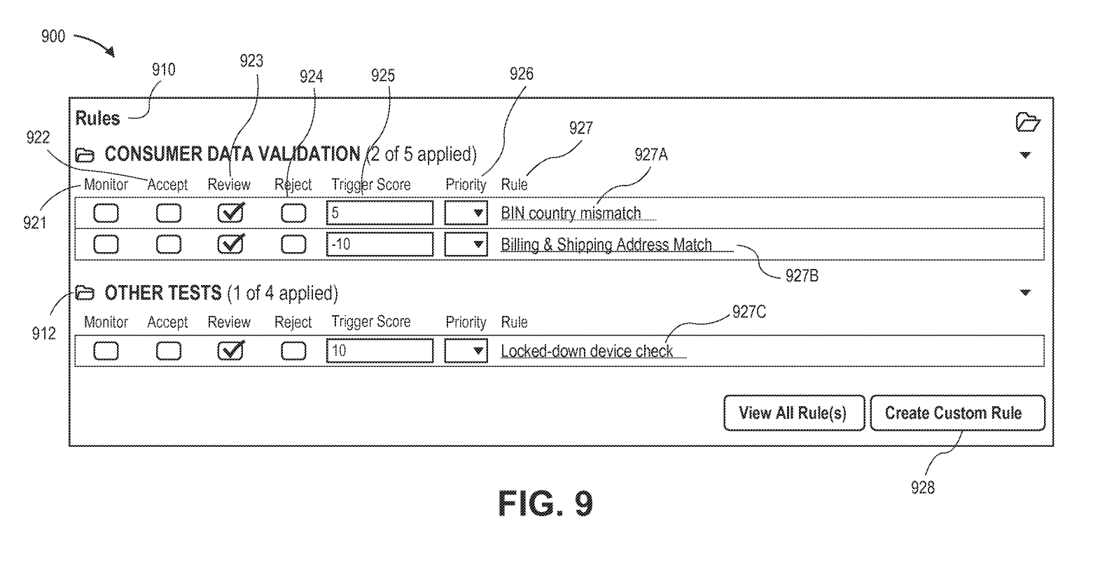

For example, as shown in FIG. 8B, the merchant may set a multiple merchant hybrid score adjustment profile rule 836B that implements an initial profile score 820B of the multiple merchant score 821B for the transaction, but then alters the multiple merchant profile score 821B according to the rules defined in the multiple merchant hybrid score adjustment profile score rule 836B. Multiple profile rules may be contained in the same profile score graphical user interface and the different profile rules may be activated or deactivated by the engagement or checking of the transaction decision rules of 831B-834B as shown. Additionally, the priority field 835B may give priority to one transaction decision rule over another. Accordingly, the screen provides an easy and intuitive interface for a merchant to quickly and easily see which rules 836B are activated and correspond to which transaction decisions 831B-834B and in which priority 835B. Although the conditional merchant rules that make up a merchant profile are not shown in FIGS. 8A and 8B, in some embodiments the merchant rules may further be shown under each transaction decision rule 836B. In the embodiment shown in FIGS. 8A and 8B, the profile rules may be selected or interacted with to open a rules window as shown in FIG. 9.

FIG. 9 shows an exemplary graphical user interface for a merchant to generate and select custom merchant rules including rule conditions 927A, 927B and trigger scores 925. The custom merchant rules may be divided by type of information that the rule is conditional on, for example, consumer data validation 911 versus other types of information 912. The merchant rules 927 may be predefined by the merchant processor or a merchant may create a custom rule 928. If the merchant creates a custom rule using the “create custom rule” button 928, the merchant may be provided with a list of available fields that may be used to create the rule and may select conditions for those fields. This process and graphical user interface may be similar to that provided in FIGS. 7A and 7B but may be directed at creating custom conditional rules associated with transaction data instead of custom merchant profile score rules. The custom rules may be named and stored in a section that allows the merchant to import them into a profile. For example, the rules 927 that make up the multiple merchant hybrid score adjustment profile shown in FIG. 8B may include a BIN Country Mismatch rule 927A, Billing and shipping address match rule 927B, and a locked-down device check rule 927C. The three rules have trigger scores set for 5, −10, and 10 points, respectively. Accordingly, the multiple merchant profile score may be adjusted by anywhere from −10 to 15 points depending on which and how many of the rules are triggered by a transaction. Accordingly, the triggered rules may have a positive or negative effect on the multiple merchant profile score depending on which rules are triggered by a transaction. Although the individual rules may include transaction decisions associated with the individual rules, these transaction decisions may be ignored within the merchant profile or may be implemented in conjunction with the merchant profile.

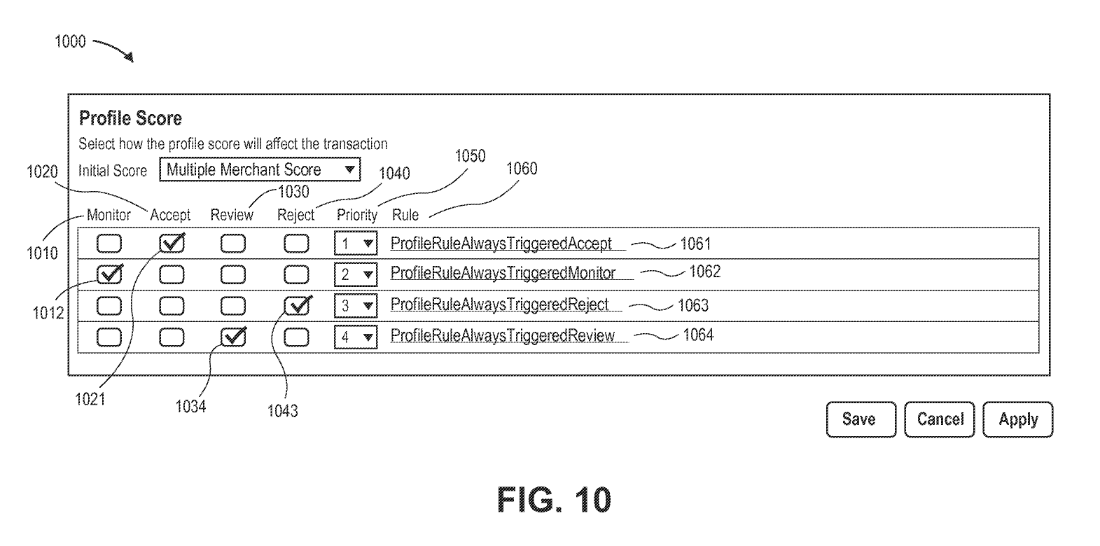

FIG. 10 shows an exemplary graphical user interface for a merchant to configure a hybrid custom merchant profile for use with embodiments of the present invention. The hybrid transaction scorecard screenshot 1000 focuses on the configuration of the transaction decision rules for a hybrid merchant profile 1000 using multiple different custom merchant profile score rules 1061-1064. The multiple merchant score is provided by a merchant processor and the transaction decisions 1010-1040 (Monitor, Accept, Review, and Reject) along with priorities and rules 1050 are selected by the merchant for the custom merchant profile. FIG. 10 shows the equivalent of the transaction decision rules of FIGS. 4 and 6 described above, where the various transaction decisions may be determined based on point ranges of profile scores. Additionally, the rules provide an example of an exception rule that if triggered, may make a certain action occur, no matter the score. For example, the transaction decision rules may include predetermined rules that automatically accept, monitor, reject, or review a transaction (in that order due to the priority settings 1050). Accordingly, the accept rule may trump or override any other exception. The exception rules allow the merchant more versatility and customization of the profile transaction decision rules.

FIG. 11 shows an exemplary embodiment of a hybrid transaction scorecard 1100 according to another embodiment of the present invention. The hybrid transaction scorecard 1100 shows transaction data associated with the received transaction, the profile score results for both a passive fraud profile evaluation 1130 and an active fraud profile evaluation 1120, and a legend or key 1140 for interpreting the transaction results. The active profile evaluation 1120 directly affects the outcome of the transaction. Passive profile evaluation 1130 is used in the background to test other merchant profiles that may not be ready to implement yet in order to see what the results may be for the passive profile without directly affecting the transaction. By using both passive profile fraud evaluation and active profile fraud evaluation, merchants can test rules without being concerned that if a mistake is made, they may be responsible for any fraudulent transactions they allow during the testing phase.

The transaction scorecard including the transaction evaluation results shows the name of the active profile 1222, the transaction decision for the transaction 1223, and the profile score for the transaction 1224, rules that affected the transaction 1125 (i.e., triggered rules), and rules that did not affect the transaction 1127 (i.e., untriggered rules). Each section showing the triggered and untriggered rules shows the trigger score of the rules if they were or would have been triggered, the transaction decision that is associated with each rule that was or was not triggered, and the name of the rule. As can be seen, not all rules that are triggered may have a point value associated with them because they could be used in exception rules or be set to 0 for certain test results or otherwise. As can be seen in the exemplary hybrid transaction scorecard, merchants can set any values and can customize the active or passive profiles to their needs.

The passive profile evaluation 1130 provides a similar analysis to the active profile evaluation 1120, as explained above. A legend or key 1240 showing exemplary rule codes can be seen on the right-hand side of the screen. The legend or key 1140 may inform the merchant what a rule written in shorthand means, what a code may mean in the transaction stream, etc.

### D. Comparison of Profile Scores

FIG. 12 shows an exemplary report including a comparison of profile scores for a multiple merchant profile score and custom merchant profile score according to an exemplary embodiment of the present invention. Graphical and statistical analysis may be provided in a separate report (or as part of the transaction scorecard) that compares the custom merchant profile scores to the multiple merchant profile scores, the passive profile scores, the hybrid model profile scores, or any other profiles that may be associated with a merchant.

As shown in FIG. 12, a graphical presentation of the profile scores for historical transactions associated with a merchant may be displayed in the same graphic. The historical profile score information may be provided in an easily understandable graphic showing a merchant of the different results that may be provided between different profiles or through any other suitable data presentation format. For example, in FIG. 12, the solid line 1320 shows the profile scores for a custom merchant profile and the dotted line 1330 shows the profile scores for a multiple merchant profile over a large number of transactions. The x-axis includes the profile score 1211 for the profiles and the y-axis includes the number of transactions 1212 that had a particular profile score for each of the profiles. The sample of transactions used in the analysis may be limited by time, period, type, or any other suitable method. For example, the transactions may include all of the transactions that have been received in the last 3 months, the last year, all transactions for a particular type of product, or any other suitable type of information. The transaction decisions 1213-1216 for the profiles may be normalized for different point scales between the two profiles. The transaction decisions may be shown on the graph to easily inform a merchant of what transaction decisions occurred or would have occurred if each profile were active for the transactions. As can be seen between the two line graphs, some profiles may have large differences between custom merchant profile scores 1220 and multiple merchant profile scores 1230. Although not shown on the graphic, statistics may also be provided that indicate the percentage of transactions that are accepted, reviewed, monitored, or rejected for each profile and the differences between the profiles.

Additionally, more than two profiles may be analyzed and the graphics may be interactive such that profiles may be updated. The updated results may be shown on the graph for how the changes would have affected the profile scores. Furthermore, as described above in regards to the embodiments of the exemplary system, the statistics, transaction results, etc., may be stored and saved to a database or a local memory such that past performances of a particular profile or rule can be compared to the current transaction.

In this fashion, the merchant can quickly and easily determine which model is the most accurate as well as quickly and easily determine whether changes in the customized model are required or may be beneficial. If the scores are provided on different scales (e.g. the multiple merchant profile score is provided in a range from 0-99 but the custom merchant score can be as high as 200 or more) the scores can be normalized prior to comparison so that statistically relevant results can be provided.

### III. TECHNICAL ADVANTAGES

The transaction scorecard allows analysts to quickly understand which rules are responsible for which actions. The layout lends itself to pinpointing any redundancies and inefficiencies in a given rule set. Prior to the scorecard, understanding the interrelationship of rules was a data-intensive and time-intensive process. Furthermore, the customizable merchant profile provides the advantage of merchants being able to build their own model based on their own business environment. Merchants are given control over their fraud prevention profiles and can customize the fraud rules to their business model which may provide better results and better fraud prevention. Additionally, the scorecard allows merchants to quickly and easily compare predefined fraud profiles and rule results against their custom merchant profile results. Furthermore, by requiring that all the fraudulent rules are run in the profile for every transaction, even if a decision threshold has been reached and a transaction decision is inevitable, the service provides the additionally benefit of providing a robust set of data that can be used to develop future fraud prevention rules more efficiently. The access to more transaction results and more statistically relevant data is important for determining fraud profile accuracy in the future. Additionally, because it is determined whether each and every rule is triggered, the merchant does not have to be concerned with the order that the rules are set in the profile because they may all be run and a profile score may be determined regardless of their order. This simplifies the creating of custom merchant profiles and creates more accurate results because each and every rule is determined and a final score is determined for every transaction.

Embodiments of the invention provide an easy tool for merchants and other developers to provide sophisticated fraud protection that is customized to their particular business. Embodiments provide the technical advantages of improved protection from fraudulent transactions. Additionally, the scorecard display of the transaction results improves the speed, efficiency, and accuracy of fraud prevention rule development and testing. Finally, storing of the transaction results for later review allows developers to further improve testing and development by using new rules or weighting of profiles on past transaction data to improve the speed and efficiency of implementing new fraud rules.

### IV. ADDITIONAL EXEMPLARY EMBODIMENTS

As explained above, exemplary embodiments of the present invention may include a method of performing a fraud evaluation for a transaction. The method may include determining if one or more preselected rules are triggered by transaction data associated with a transaction. The method continues by determining a trigger score for each of the preselected rules, adding the trigger score for each of the preselected rules to a profile score, applying the profile score to at least one transaction decision rule, and displaying transaction evaluation results in a transaction scorecard. Determining the trigger score for each of the preselected rules may further include setting the trigger score for the preselected rule to a preselected point value if a preselected rule of the one or more preselected rules is triggered, and setting the trigger score for the preselected rule to zero if the preselected rule of the one or more preselected rules is not triggered.

Additional embodiments of the present invention may include the method above, wherein the transaction scorecard provides a report that compares two profile scores using historical transactions and displays the comparison information in a graphical representation. The graphical representation may plot the two or more profile scores over a plurality of transactions. In some embodiments, the two or more profile scores may include a custom profile score, a multiple merchant profile score, and a hybrid profile score. In some embodiments, the scores are normalized prior to comparison so that statistically relevant results can be provided. Furthermore, in some embodiments, the graphical representation may include transaction decision rule profile score ranges and a corresponding transaction decision.

In another embodiment, the method described above may include transaction decision rules where lower profile score points indicate fraud.

In another embodiment, the method described above may include transaction decision rules that are conditional on transaction data and a profile score.

In another embodiment, the method described above may include transaction decision rules including an exception rule, wherein if the exception rule is triggered, an action occurs, and the method further comprises evaluating the predetermined rules to determine if each rule is triggered and a corresponding trigger score before storing the transaction evaluation results.

Additional exemplary embodiments of the present invention may include a method of generating a custom merchant profile. The method may include a merchant generating a custom merchant profile score rule, selecting a plurality of merchant rules, and generating a transaction decision rule. Generating a custom merchant profile score rule may further include selecting a conditional statement, selecting an order element to evaluate, selecting a comparison operator, and selecting a comparison value. The step of selecting a plurality of merchant rules may include selecting a merchant rule from a plurality of predetermined rules and generating a custom merchant rule. Generating a custom merchant rule may further include selecting a condition associated with transaction data and selecting a trigger score. The step of generating a transaction decision rule may further include selecting an initial score, selecting a transaction decision, selecting the custom merchant profile score rule, and selecting a priority for the transaction decision.

### V. EXEMPLARY COMPUTER SYSTEMS

FIG. 13 is a high level block diagram of a computer system that may be used to implement any of the entities or components described above. The subsystems shown in FIG. 13 are interconnected via a system bus 1302. Additional subsystems such as a printer 1310, keyboard 1318, fixed disk 1320, and monitor 1312, which is coupled to display adapter 1314. Peripherals and input/output (I/O) devices, which couple to I/O controller 1304, can be connected to the computer system by any number of means known in the art, such as serial port 1384. For example, serial port 1316 or external interface 1322 can be used to connect the computer apparatus to a wide area network such as the Internet, a mouse input device, or a scanner. The interconnection via system bus 1302 allows the central processor 1308 to communicate with each subsystem and to control the execution of instructions from system memory 1306 or the fixed disk 1320, as well as the exchange of information between subsystems. The system memory 1306 and/or the fixed disk 1320 may embody a computer readable medium.

As described, the inventive service may involve implementing one or more functions, processes, operations or method steps. In some embodiments, the functions, processes, operations or method steps may be implemented as a result of the execution of a set of instructions or software code by a suitably programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary. Additionally, although the description of the invention refers to merchants, the meaning of merchant is the entity processing a transaction, meaning the merchant could be anyone representing a merchant entity. Additionally, one of ordinary skill in the art could determine users other than merchants or merchant representatives which may find the underlying fraud prevention process and scorecard beneficial.

What is claimed is:

1. A method of performing a fraud evaluation for a transaction, the method comprising:
determining, by one or more processors, if one or more preselected rules are triggered by transaction data, wherein the transaction data is associated with the transaction;
determining a trigger score for each of the preselected rules;
adding the trigger score for each of the preselected rules to a profile score;
applying the profile score to at least one transaction decision rule; and
displaying transaction evaluation results in a transaction scorecard.

2. The method of claim 1, wherein the transaction scorecard includes the one or more preselected rules, the trigger score for each of the preselected rules, the profile score, the at least one transaction decision rule, and the result of the transaction decision rule.

3. The method of claim 2, wherein the transaction scorecard further includes a passive profile score, wherein the passive profile score is not used in the fraud evaluation of the transaction.

4. The method of claim 1, wherein determining the trigger score for each of the preselected rules further comprises:
if a preselected rule of the one or more preselected rules is triggered, setting the trigger score for the preselected rule to a preselected point value; and
if the preselected rule of the one or more preselected rules is not triggered, setting the trigger score for the preselected rule to zero.

5. The method of claim 1, wherein the profile score is equal to a predetermined number prior to adding the trigger score for any of the preselected rules.

6. The method of claim 1, further comprising:
executing the determined transaction decision determined from the at least one transaction decision rule;
storing the transaction scorecard and the associated transaction data,
tracking the status of the transaction; and
updating the transaction scorecard with the status of the transaction.

7. The method of claim 1, wherein the transaction scorecard is interactive, and wherein the transaction scorecard allows a merchant to request another fraud evaluation for the transaction using updated trigger scores, preselected rules, and transaction decision rules.

8. A server computer comprising:
a processor; and
a computer-readable medium coupled to the processor, the computer-readable medium comprising code executable by the processor for performing a method of performing a fraud evaluation for a transaction, the method comprising:
determining, by one or more processors, if one or more preselected rules are triggered by transaction data, wherein the transaction data is associated with the transaction;
determining a trigger score for each of the preselected rules;
adding the trigger score for each of the preselected rules to a profile score;
applying the profile score to at least one transaction decision rule; and
displaying transaction evaluation results in a transaction scorecard.

9. The server computer of claim 8, wherein the transaction scorecard includes the one or more preselected rules, the trigger score for each of the preselected rules, the profile score, the at least one transaction decision rule, and the result of the transaction decision rule.

10. The server computer of claim 8, wherein determining a trigger score for each of the preselected rules further comprises:
if a preselected rule of the one or more preselected rules is triggered, setting the trigger score for the preselected rule to a preselected point value;
if the preselected rule of the one or more preselected rules is not triggered, setting the trigger score for the preselected rule to zero.

11. The server computer of claim 8, wherein the computer-readable medium comprising code executable by the processor for performing a method of performing a fraud evaluation for a transaction further comprises code for:
executing the determined transaction decision determined from the at least one transaction decision rule;
storing the transaction scorecard and the associated transaction data,
tracking the status of the transaction; and
updating the transaction scorecard with the status of the transaction.

12. The method of claim 8, wherein the transaction scorecard is interactive, and wherein the transaction scorecard allows a merchant to request another fraud evaluation for the transaction using updated trigger scores, preselected rules, and transaction decision rules.

13. A method of performing a fraud evaluation for a transaction, the method comprising:
determining a multiple merchant profile score for the transaction;
determining a weighted multiple merchant profile score, wherein the multiple merchant profile score is weighted by a preselected multiple merchant profile weighting;
determining a custom merchant profile score for the transaction;
determining a weighted custom merchant profile score, wherein the custom merchant profile score is weighted by a preselected custom merchant profile weighting;
determining a hybrid profile score for the transaction by adding the weighted multiple merchant profile score and the weighted custom merchant profile score;
applying, by one or more processors, the hybrid profile score to at least one transaction decision rule; and
displaying transaction evaluation results in a hybrid transaction scorecard for a merchant.

14. The method of claim 13, wherein determining a multiple merchant profile score is determined.

15. The method of claim 13, wherein the transaction scorecard includes the one or more preselected rules, the trigger score for each of the preselected rules, the custom merchant profile score, the multiple merchant profile score, the at least one transaction decision rule, and the result of the transaction decision rule.

16. The method of claim 13, wherein determining a custom merchant profile score further comprises:
determining, by one or more processors, if one or more preselected rules are triggered by the transaction data, wherein the transaction data is associated with the transaction;
determining a trigger score for each of the preselected rules; and
adding the trigger score for each of the preselected rules to a profile score.

17. A server computer comprising:
a processor; and
a computer-readable medium coupled to the processor, the computer-readable medium comprising code executable by the processor for performing a method of performing a fraud evaluation for a transaction, the method comprising:
determining a multiple merchant profile score for the transaction;
determining a weighted multiple merchant profile score, wherein the multiple merchant profile score is weighted by a preselected multiple merchant profile weighting;
determining a custom merchant profile score for the transaction;
determining a weighted custom merchant profile score, wherein the custom merchant profile score is weighted by a preselected custom merchant profile weighting;
determining a hybrid profile score for the transaction by adding the weighted multiple merchant profile score and the weighted custom merchant profile score;
applying, by one or more processors, the hybrid profile score to at least one transaction decision rule; and
displaying transaction evaluation results in a hybrid transaction scorecard for a merchant.

18. The server computer of claim 17, wherein determining a multiple merchant profile score is determined.

19. The server computer of claim 17, wherein the transaction scorecard includes the one or more preselected rules, the trigger score for each of the preselected rules, the custom merchant profile score, the multiple merchant profile score, the at least one transaction decision rule, and the result of the transaction decision rule.

20. The server computer of claim 17, wherein determining a custom merchant profile score further comprises:
determining, by one or more processors, if one or more preselected rules are triggered by the transaction data, wherein the transaction data is associated with the transaction;
determining a trigger score for each of the preselected rules; and
adding the trigger score for each of the preselected rules to a profile score.
